(19) United States
(12) Patent Application Publication
(10) Pub. No.: US 2025/0262810 A1
(43) Pub. Date: Aug. 21, 2025

(54) METHOD AND SYSTEM FOR FABRICATING A POROUS STRUCTURE BASED ON EXTRUSION-BASED ADDITIVE MANUFACTURING, AND POROUS STRUCTURE THEREOF

(71) Applicant: SINGAPORE UNIVERSITY OF TECHNOLOGY AND DESIGN, Singapore (SG)

(72) Inventors: Jian Yi Mervin NG, Singapore (SG); Michinao HASHIMOTO, Singapore (SG)

(73) Assignee: SINGAPORE UNIVERSITY OF TECHNOLOGY AND DESIGN, Singapore (SG)

(21) Appl. No.: 18/702,437

(22) PCT Filed: Oct. 18, 2022
(86) PCT No.: PCT/SG2022/050741

§ 371 Date: Apr. 18, 2024

(30) Foreign Application Priority Data
Oct. 18, 2021 (SG) 10202111559S

(51) Int. Cl. B29C 48/92; B29C 48/05; B29C 64/343; B29K 105/04; B33Y 10/00; B33Y 30/00

(52) U.S. Cl. CPC B29C 48/92; B29C 48/05; B29C 64/343; B29C 2948/926; B29K 2105/04; B33Y 10/00; B33Y 30/00

(57) ABSTRACT

A method of fabricating a porous structure based on extrusion-based additive manufacturing is provided. The method includes: controlling a print head of an extruder to move along a print path for extruding a material along the print path on a print bed for fabricating the porous structure; and adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion being formed adjacent to and opposing the first extruded material portion, such that a space formed therebetween constitutes the pore. A corresponding system for fabricating a porous structure and the fabricated porous structure are also provided.

### CROSS-REFERENCE TO RELATED APPLICATION

This application claims the benefit of priority of Singapore patent application Ser. No. 10202111559S, filed on 18 Oct. 2021, the content of which being hereby incorporated by reference in its entirety for all purposes.

### TECHNICAL FIELD

The present invention generally relates to a method and a system for fabricating a porous structure based on extrusion-based additive manufacturing, and a porous structure thereof.

### BACKGROUND

Porosity of a fabricated structure may be defined as total void space(s) within a structure over its nominal volume. Pores have an impact on different mechanical properties depending on their configurations (e.g., geometry, dimension and location) within the fabricated structure. Existing digital fabrication techniques include sacrificial templating and direct additive manufacturing for fabricating a porous structure. The former technique uses a sacrificial material mixed in a matrix with the desired material being for forming the intended geometry of the porous structure. By removing the sacrificial material with chemical processes, void spaces are left behind in the matrix, thereby fabricating the porous structure. However, such a technique is generally tedious and inefficient as it requires multiple steps. Furthermore, the configurations (e.g., locations and orientations) of the pores in the porous structure cannot be controlled. The latter technique offers more freedom in designing pore geometries and dimensions based on toolpath due to the precise or direct construction of pores with digital control of the fabrication process. For example, conventional slicer software may enable a variety of pore shapes that form repeating units of a particular geometry within the porous structure. However, the porosity created in this manner is limited to homogeneous distribution within the porous structure, which inhibits variation of mechanical properties within the fabricated structure (e.g., a 3D-printed structure) (e.g., inhibiting porosity design control or flexibility).

On the other hand, algorithmic approaches generate non-uniform toolpaths that fill the internal structure of a geometry. In this regard, the geometry refers to the exterior and interior structure or shape that has been designed or configured. For example, to fabricate a particular geometry according to algorithmic approaches, an internal structure (that may not be visible after fabrication) may be required to fill the geometry during fabrication to prevent the built structure from collapsing (e.g., a structure may collapse if it is hollow when being built). However, the internal structure cannot be fully filled as well, for example, because the fabrication time would be too long and excessive material usage is not cost-effective. Hence, the heterogeneous distribution of porosity achieves an elasticity-rigidity contrast within the whole structure. Nonetheless, production speed is impeded due to multiple machine movements required to complete the non-uniform or discontinuous toolpaths. Moreover, the intricate microstructures generated according to user interaction is non-intuitive due to the convoluted processing steps that are difficult to follow.

Accordingly, existing extrusion-based additive manufacturing techniques for generating pores in a structure (e.g., fused deposition modeling (FDM) 3D printing) have a number of technical problems or challenges, such as but not limited to, porosity design/configuration control difficulty (e.g., difficulty to precisely control or distribute the locations of the pores, e.g., for a heterogeneous gradient of mechanical properties, such as in the above-mentioned existing sacrificial templating and direct additive manufacturing techniques) and process inefficiencies and/or ineffectiveness (e.g., complex pore distributions compromise production speed due to additional machine movements and complex processes involve convoluted processing steps that are non-intuitive for users, such as in the above-mentioned existing algorithmic approaches).

A need therefore exists to provide a method and a system for fabricating a porous structure based on extrusion-based additive manufacturing, that seek to overcome, or at least ameliorate, one or more problems associated with conventional methods and systems for fabricating a porous structure based on extrusion-based additive manufacturing, and in particular, providing an improved method and system that enable or enhance porosity design/configuration control in an efficient and/or effective manner. It is against this background that the present invention has been developed.

### SUMMARY

According to a first aspect of the present invention, there is provided a method of fabricating a porous structure based on extrusion-based additive manufacturing using at least one processor, the method comprising:
controlling a print head of an extruder to move along a print path for extruding a material along the print path on a print bed for fabricating the porous structure; and
controlling an extrusion flow rate of the extruder, while the print head is being controlled to move along the print path for extruding the material, for forming a plurality of pores of the porous structure, wherein for each pore of the plurality of pores, said controlling the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

According to a second aspect of the present invention, there is provided a system for fabricating a porous structure based on extrusion-based additive manufacturing, the system comprising:
at least one memory; and
at least one processor communicatively coupled to the at least one memory and configured to:
control a print head of an extruder to move along a print path for extruding a material along the print path on a print bed for fabricating the porous structure; and
control an extrusion flow rate of the extruder, while the print head is being controlled to move along the print path for extruding the material, for forming a plurality of pores of the porous structure, wherein for each pore of the plurality of pores, said control the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

According to a third aspect of the present invention, there is provided a porous structure fabricated according to the method according to the above-mentioned first aspect of the present invention.

According to a fourth aspect of the present invention, there is provided a computer program product, embodied in one or more non-transitory computer-readable storage mediums, comprising instructions executable by at least one processor to perform the method of fabricating a porous structure based on extrusion-based additive manufacturing according to the above-mentioned first aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method of fabricating a porous structure based on extrusion-based additive manufacturing, according to various embodiments of the present invention;

FIG. 2 depicts a schematic block diagram of a system for fabricating a porous structure based on extrusion-based additive manufacturing, according to various embodiments of the present invention;

FIG. 3 depicts a schematic block diagram of an exemplary computer system which may be used to realize or implement the system for fabricating a porous structure based on extrusion-based additive manufacturing, according to various embodiments of the present invention;

FIG. 4 depicts a schematic drawing illustrating example print parameters which may be controlled or manipulated to control or manipulate the extrusion flow rate, according to various embodiments of the present invention;

FIGS. 5A to 5C illustrate an example control of a material extrusion flow rate of the extruder for forming a pore according to various example embodiments of the present invention (bottom row of FIGS. 5A to 5C), compared to a conventional material extrusion with a fixed extrusion flow rate (top row of FIGS. 5A to 5C);

FIG. 6 depicts a schematic drawing of two example adjacent and opposing extruded material portions along two adjacent and opposing sections of the toolpath, respectively, configured to form an example pore therebetween, according to various embodiments of the present invention;

FIG. 7A illustrates various types of functions that may be applied for controlling or determining the feed rate, according to various example embodiments of the present invention;

FIG. 7B illustrates an example implementation or utilization of a linear function for controlling or determining the feed rate with respect to first and second sections of the print path for forming a pore, according to various example embodiments of the present invention;

FIGS. 8A to 8D illustrate the effects of various operations applied to different types of functions for forming a variety of pore geometries, including symmetrical pores and asymmetrical pores, according to various example embodiments of the present invention;

FIG. 9A illustrates an example implementation of a linear function for controlling or determining the feed rate with respect to first and second sections of the print path for forming a pore, as well as simultaneously controlling or determining the print speed with respect to the first and second sections based on the linear function, according to various example embodiments of the present invention;

FIG. 9B shows pictures of extruded material portions formed at different print speeds for illustrating the potential issue relating to discontinuous material extrusion, according to various example embodiments of the present invention;

FIGS. 10A and 10B depict an example implementation of the quadratic function for forming a pore whereby the minimum feed rate (minFR) was gradually varied, according to various example embodiments of the present invention, and a plot thereof illustrating the substantially linearly proportional relationship between the pore thickness measurements and the corresponding minimum feed rate values (minFR);

FIGS. 11A and 11B depict an example implementation of the quadratic function for forming a pore whereby the positions of nodes in each of the two adjacent and opposing sections of the toolpath for forming the pore were varied (ΔX), according to various example embodiments of the present invention, and a plot thereof illustrating the substantially linearly proportional relationship between the pore width measurements and the corresponding maximum node separation distance values (maxΔX);

FIGS. 12A to 12H depict an example technique or workflow for arranging or configuring a plurality of pores to form a mechanical property varied portion at specific or desired locations within the fabricated structure, according to various example embodiments of the present invention;

FIGS. 13A to 13D illustrate four two-layered planar printed structures with different distributions of pores, namely, vertical, diagonal, cross and curve arrangements or distributions, along with their reshaped 3D structures, according to various example embodiments of the present invention; and

FIGS. 14A to 14E depict pictures of an example finger brace fabricated, according to various example embodiments of the present invention.

### DETAILED DESCRIPTION

Various embodiments of the present invention provide a method and a system for fabricating a porous structure based on extrusion-based additive manufacturing, and a porous structure thereof. For example, as explained in the background, existing extrusion-based additive manufacturing techniques for generating pores in a structure (e.g., FDM 3D printing) have a number of technical problems or challenges, such as but not limited to, porosity design/configuration control difficulty (e.g., difficulty to precisely distribute the locations of the pores, e.g., for a heterogeneous gradient of mechanical properties) and process inefficiencies and/or ineffectiveness (e.g., complex pore distributions compromise production speed due to additional machine movements and complex processes involve convoluted processing steps that are non-intuitive for users). Accordingly, various embodiments of the present invention provide a method and a system for fabricating a porous structure based on extrusion-based additive manufacturing, that seek to overcome, or at least ameliorate, one or more problems associated with conventional methods and systems for fabricating a porous structure based on extrusion-based additive manufacturing, and in particular, providing an improved method and system that enable or enhance porosity design/configuration control in an efficient and/or effective manner.

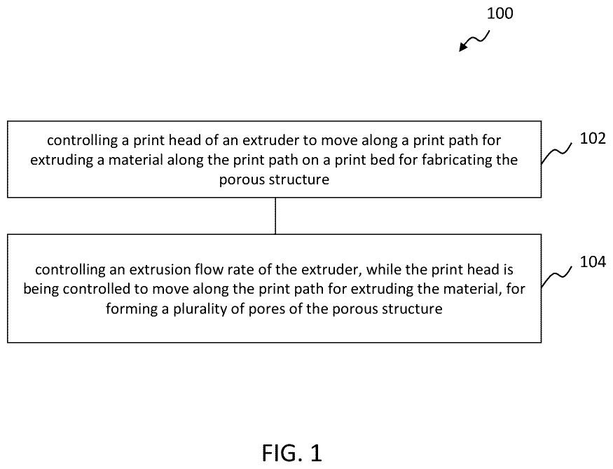

FIG. 1 depicts a schematic flow diagram of a method 100 of fabricating a porous structure based on extrusion-based additive manufacturing using at least one processor, according to various embodiments of the present invention. The method 100 comprises: controlling (at 102) a print head of an extruder to move along a print path for extruding a material along the print path on a print bed for fabricating the porous structure; and controlling (at 104) an extrusion flow rate of the extruder, while the print head is being controlled to move along the print path for extruding the material, for forming a plurality of pores of the porous structure. In particular, for each pore of the plurality of pores, the above-mentioned controlling (at 104) the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

Accordingly, the method 100 may be applied to control an extrusion-based additive manufacturing system for fabricating a porous structure as described herein according to various embodiments of the present invention. It will be understood by a person skilled in the art that the present invention is not limited to any particular type of extrusion-based additive manufacturing system as long as the extrusion flow rate of the extruder of the extrusion-based additive manufacturing system is capable of being controlled (e.g., digitally control, such as based on controlling the filament feed rate of the extruder) as described herein according to various embodiments of the present invention, such as but not limited to, fused deposition modeling (FDM) systems (which may also be referred to as fused filament fabrication (FFF)). Furthermore, various types of extrusion-based additive manufacturing systems, as well as various components thereof such as an extruder including a print head and a feeding mechanism (e.g., comprising motor and gears) for feeding a filament of the material to the print head, and a print head movement mechanism (e.g., comprising motor and gears)), are known to a person skilled in the art, and thus they do not need to be described in detail herein for clarity and conciseness. Accordingly, the above-mentioned controlling (at 102) the print head to move along a print path may comprise controlling the print head movement mechanism to move the print head along the print path. In various embodiments, the above-mentioned controlling (at 104) the extrusion flow rate of the extruder may comprise controlling a feed rate of the extruder for feeding a filament of the material to the print head, and thus, may comprise controlling the feeding mechanism for feeding a filament of the material to the print head so as to control the feed rate of the extruder.

In various embodiments, the first section of the print path may be along a first line of the print path and the second section of the print path may be along a second line of the print path whereby the first line and the second line are adjacent and opposing each other. For example, the second line may be an immediately subsequent line to the first line or substantially parallel to the first line. Accordingly, the second extruded material portion formed is adjacent to and opposing (or facing) the first extruded material portion formed.

Accordingly, the method 100 of fabricating a porous structure advantageously enables or enhances porosity design/configuration control in an efficient and/or effective manner. In particular, by controlling an extrusion flow rate of the extruder, while the print head is being controlled to move along the print path for extruding the material, for forming a plurality of pores of the porous structure, for example, the arrangement or locations of the plurality of pores in the porous structure can be accurately or effectively controlled (i.e., by controlling the extrusion flow rate with respect to those locations where the plurality of pores are desired or intended to be formed). Furthermore, as the extrusion flow rate is controlled while the print head is being controlled to move along the print path for extruding the material (i.e., simultaneously), the print path for forming fabricating the porous structure is advantageously not disrupted (e.g., compared to conventional approaches whereby the print path is modified to directly print the outlines of the pores). Therefore, the method 100 of fabricating a porous structure advantageously enables or enhances porosity design/configuration control in an efficient and/or effective manner. These advantages or technical effects, and/or other advantages or technical effects, will become more apparent to a person skilled in the art as the method 100 of fabricating a porous structure, as well as the corresponding system for fabricating a porous structure, is described in more detail according to various embodiments and example embodiments of the present invention.

In various embodiments, the above-mentioned adjusting the extrusion flow rate with respect to the first section of the print path comprises decreasing the extrusion flow rate with respect to the first section of the print path. Similarly, the above-mentioned adjusting the extrusion flow rate with respect to the second section of the print path comprises decreasing the extrusion flow rate with respect to the second section of the print path. For example, the extrusion flow rate with respect to the first section may be decreased compared to a section of the print path immediately prior to and/or after (with respect to the printing direction or the print head movement direction) the first section. Similarly, the extrusion flow rate with respect to the second section may be decreased compared to a section of the print path immediately prior to and/or after (with respect to the printing direction) the second section.

In various embodiments, the above-mentioned decreasing the extrusion flow rate with respect to the first section of the print path forms the first extruded material portion along the first section of the print path having a thickness less than an extruded material portion formed along the print path immediately prior to and/or after (with respect to the printing direction) the first extruded material portion. Similarly, the above-mentioned decreasing the extrusion flow rate with respect to the second section of the print path forms the second extruded material portion along the second section of the print path having a thickness less than an extruded material portion formed along the print path immediately prior to and/or after (with respect to the printing direction) the second extruded material portion. In various embodiments, the thickness of an extruded material portion is with respect to a width of the extruded material portion in a direction perpendicular to a printing direction (for forming the extruded material portion) and a surface of the print bed on which the extruded material portion is formed.

In various embodiments, the above-mentioned decreasing the extrusion flow rate with respect to the first section of the print path and the above-mentioned decreasing the extrusion flow rate with respect to the second section of the print path are each performed based on (or according to) a function having an output corresponding the extrusion flow rate. In various embodiments, the function used for decreasing the extrusion flow rate with respect to the first section may be the same as or different to the function used for decreasing the extrusion flow rate with respect to the second section.

In various embodiments, the above-mentioned decreasing the extrusion flow rate with respect to the first section of the print path comprises setting the extrusion flow rate with respect to a first plurality of positions along the first section of the print path based on a first plurality of outputs of the function with respect to the first plurality of positions, respectively. Similarly, the above-mentioned decreasing the extrusion flow rate with respect to the second section of the print path comprises setting the extrusion flow rate with respect to a second plurality of positions along the second section of the print path based on a second plurality of outputs of the function with respect to the second plurality of positions, respectively. Accordingly, in various embodiments, the plurality of positions may be a variable (or input variable) of the function, and the extrusion flow rate value may be an output of the function based on, or corresponding to, the input variable. In various embodiments, the extrusion flow rate may be controlled based on controlling the filament feed rate of the extruder. Accordingly, in various embodiments, controlling the extrusion flow rate may correspond to controlling the feed rate of the extruder, and thus, the feed rate of the extruder may be controlled based on the above-mentioned function whereby the output of the function may correspond to the feed rate.

In various embodiments, the above-mentioned function is a polynomial function.

In various embodiments, the method 100 further comprises controlling a profile shape of the pore formed based on a first input parameter for configuring a degree of the polynomial function.

In various embodiments, the method 100 further comprises configuring the polynomial function based on a second input parameter for setting a maximum extrusion flow rate and a third input parameter for setting a minimum extrusion flow rate. In various embodiments, since controlling the extrusion flow rate may correspond to controlling the feed rate of the extruder, the second input parameter may be for setting a maximum feed rate and the third parameter may be for setting a minimum feed rate.

In various embodiments, as described hereinbefore, the above-mentioned controlling (at 104) the extrusion flow rate of the extruder comprises controlling a feed rate of the extruder for feeding a filament of the material to the print head. Accordingly, the above-mentioned setting the extrusion flow rate with respect to the first plurality of positions comprises setting the feed rate with respect to the first plurality of positions along the first section of the print path based on the first plurality of outputs of the function with respect to the first plurality of positions, respectively. Similarly, the above-mentioned setting the extrusion flow rate with respect to the second plurality of positions comprises setting the feed rate with respect to the second plurality of positions along the second section of the print path based on the second plurality of outputs of the function with respect to the second plurality of positions, respectively.

In various embodiments, the method 100 further comprises: for each of the first plurality of positions along the first section of the print path, controlling a print speed of the print head with respect to the position so as to have an inverse relationship to the feed rate set with respect to the position; and for each of the second plurality of positions along the second section of the print path, controlling the print speed of the print head with respect to the position so as to have the inverse relationship to the feed rate set with respect to the position. In this regard, in various embodiments, the print speed of the print head may be controlled based on an inverse of the function for controlling the feed rate of the extruder.

In various embodiments, the plurality of pores are arranged to form one or more mechanical property varied portions of the porous structure, each mechanical property varied portion being configured to facilitate bending or fracturing thereat. In this regard, the mechanical property varied portion has a mechanical property varied or modified compared to a portion of the porous structure without such pore(s), such that it facilitates bending or fracturing thereat.

In various embodiments, the material comprises a thermoplastic material, for example but not limited to, thermoplastic polyurethane (TPU), polylactic acid (PLA), polycaprolactone (PCL), polyethylene terephthalate glycol (PETG)).

In various embodiments, the thermoplastic material has a shape memory property.

In various embodiments, the print path is along a plane parallel to a surface of the print bed on which the porous structure is formed.

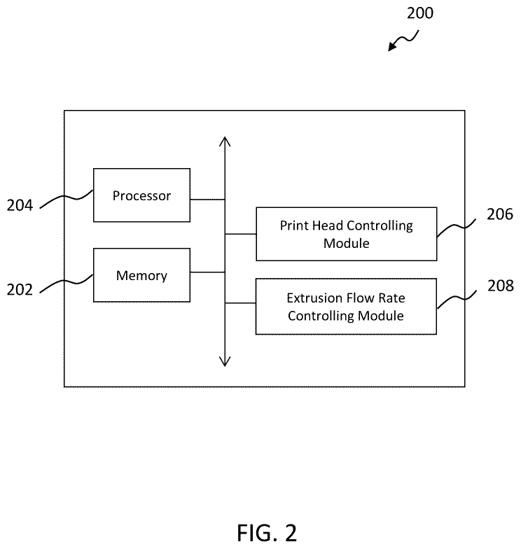

FIG. 2 depicts a schematic block diagram of a system 200 for fabricating a porous structure based on extrusion-based additive manufacturing, corresponding to the method 100 of fabricating a porous structure based on extrusion-based additive manufacturing as described hereinbefore with reference to FIG. 1 according to various embodiments of the present invention. The system 200 comprises: at least one memory 202; and at least one processor 204 communicatively coupled to the at least one memory 202 and configured to perform the above-mentioned control (at 102) a print head of an extruder to move along a print path for extruding a material along the print path on a print bed for fabricating the porous structure; and the above-mentioned control (at 104) a extrusion flow rate of the extruder, while the print head is being controlled to move along the print path for extruding the material, for forming a plurality of pores of the porous structure. In particular, for each pore of the plurality of pores, the above-mentioned control the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

It will be appreciated by a person skilled in the art that the at least one processor 204 may be configured to perform various functions or operations through set(s) of instructions (e.g., software modules) executable by the at least one processor 204 to perform various functions or operations. Accordingly, as shown in FIG. 2, the system 200 may comprise a print head controlling module (or a print head controlling circuit) 206 configured to control a print head of an extruder to move along a print path for extruding a material along the print path on a print bed for fabricating the porous structure; and an extrusion flow rate controlling module (or an extrusion flow rate controlling circuit) 208 configured to control (e.g., digitally control) an extrusion flow rate of the extruder, while the print head is being controlled to move along the print path for extruding the material, for forming a plurality of pores of the porous structure.

It will be appreciated by a person skilled in the art that the above-mentioned modules are not necessarily separate modules, and two or more modules may be realized by or implemented as one functional module (e.g., a circuit or a software program) as desired or as appropriate without deviating from the scope of the present invention. For example, two or more modules, such as the print head controlling module 206 and the extrusion flow rate controlling module 208 may be realized (e.g., compiled together) as one executable software program (e.g., software application or simply referred to as an “app”), which for example may be stored in the at least one memory 202 and executable by the at least one processor 204 to perform various functions/operations as described herein according to various embodiments of the present invention.

In various embodiments, the system 200 for fabricating a porous structure corresponds to the method 100 of fabricating a porous structure as described hereinbefore with reference to FIG. 1 according to various embodiments, therefore, various functions or operations configured to be performed by the least one processor 204 may correspond to various steps or operations of the method 100 of fabricating a porous structure as described hereinbefore according to various embodiments, and thus need not be repeated with respect to the system 200 for fabricating a porous structure for clarity and conciseness. In other words, various embodiments described herein in context of the methods are analogously valid for the corresponding systems, and vice versa.

For example, in various embodiments, the at least one memory 202 may have stored therein the print head controlling module 206 and/or the extrusion flow rate controlling module 208, which respectively correspond to various steps (or operations or functions) of the method 100 of fabricating a porous structure as described herein according to various embodiments, which are executable by the at least one processor 204 to perform the corresponding functions or operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 for fabricating a porous structure described hereinbefore may include at least one processor (or controller) 204 and at least one computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions may also be understood as a “circuit” in accordance with various embodiments. Similarly, a “module” may be a portion of a system according to various embodiments and may encompass a “circuit” as described above, or may be understood to be any kind of a logic-implementing entity.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, description or discussions utilizing terms such as “controlling”, “adjusting”, “decreasing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus), such as the system 200 for fabricating a porous structure, for performing various operations/functions of various methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform various method steps may be appropriate.

In addition, the present specification also at least implicitly discloses a computer program or software/functional module, in that it would be apparent to the person skilled in the art that individual steps of various methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the invention. It will be appreciated by a person skilled in the art that various modules described herein (e.g., the print head controlling module 206 and/or the extrusion flow rate controlling module 208) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a computer. The computer program when loaded and executed on such the computer effectively results in a system or an apparatus that implements various steps of methods described herein.

In various embodiments, there is provided a computer program product, embodied in one or more computer-readable storage mediums (non-transitory computer-readable storage medium(s)), comprising instructions (e.g., the print head controlling module 206 and/or the extrusion flow rate controlling module 208) executable by one or more computer processors to perform the method 100 of fabricating a porous structure, as described herein with reference to FIG. 1 according to various embodiments. Accordingly, various computer programs or modules described herein may be stored in a computer program product receivable by a system therein, such as the system 200 for fabricating a porous structure as shown in FIG. 2, for execution by at least one processor 204 of the system 200 to perform various functions.

Software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

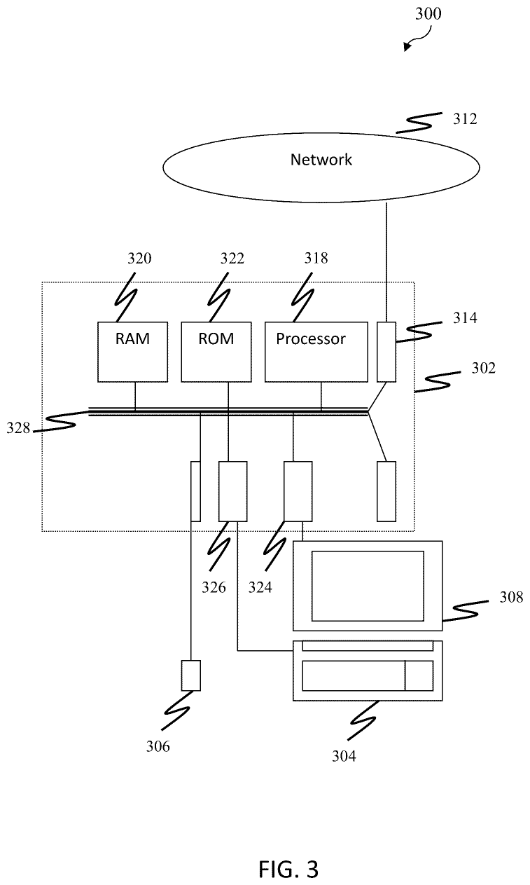

In various embodiments, the system 200 for fabricating a porous structure may be realized by any computer system (e.g., desktop or portable computer system) including at least one processor and at least one memory, such as an example computer system 300 as schematically shown in FIG. 3 as an example only and without limitation. Various methods/steps or functional modules may be implemented as software, such as a computer program being executed within the computer system 300, and instructing the computer system 300 (in particular, one or more processors therein) to conduct various functions or operations as described herein according to various embodiments. The computer system 300 may comprise a system unit 302, input devices such as a keyboard and/or a touchscreen 304 and a mouse 306, and a plurality of output devices such as a display 308. The system unit 302 may be connected to a computer network 312 via a suitable transceiver device 314, to enable access to e.g., the Internet or other network systems such as Local Area Network (LAN) or Wide Area Network (WAN). The system unit 302 may include a processor 318 for executing various instructions, a Random Access Memory (RAM) 320 and a Read Only Memory (ROM) 322. The system unit 302 may further include a number of Input/Output (I/O) interfaces, for example I/O interface 324 to the display device 308 and I/O interface 326 to the keyboard 304. The components of the system unit 302 typically communicate via an interconnected bus 328 and in a manner known to the person skilled in the art.

It will be appreciated by a person skilled in the art that the system 200 for fabricating a porous structure may be a separate system communicatively couplable or coupled to an extrusion-based additive manufacturing system for controlling the extrusion-based additive manufacturing system to fabricate the porous structure, or may be an extrusion-based additive manufacturing system configured to fabricate the porous structure according to the above-mentioned method 100 (i.e., having installed or integrated therein with such functionalities) as described hereinbefore according to various embodiments. For example, the extrusion-based additive manufacturing system may be an existing extrusion-based additive manufacturing system known in the art, such as a commercially available extrusion-based additive manufacturing system. For example, an existing extrusion-based additive manufacturing system may be installed with executable instructions (e.g., including the print head controlling module 206 and the extrusion flow rate controlling module 208) configured for performing the above-mentioned method 100 of fabricating a porous structure. In various embodiments, a user interface (e.g., touchscreen or button(s)) may be provided on or with the system 200 (e.g., on the extrusion-based additive manufacturing system if the system 200 is integrated therein) configured for receiving one or more user inputs (e.g., input parameters) for controlling the porosity design/configuration (e.g., geometry, dimension and/or locations of pores) in the porous structure to be fabricated, as will be described later below according to various example embodiments of the present invention. As mentioned hereinbefore, it will be appreciated by a person skilled in the art that the present invention not limited to any particular type of extrusion-based additive manufacturing system as long as the extrusion flow rate of the extruder of the extrusion-based additive manufacturing system is capable of being controlled (e.g., digitally controlled) as described herein according to various embodiments of the present invention, such as but not limited to, FDM systems. Furthermore, various types of extrusion-based additive manufacturing systems, as well as various components thereof such as an extruder including a print head and a feeding mechanism (e.g., comprising motor and gears) for feeding a filament of the material to the print head, and a print head movement mechanism (e.g., comprising motor and gears)), are known to a person skilled in the art, and thus they do not need to be described in detail herein for clarity and conciseness. Accordingly, in the case of the system 200 being an extrusion-based additive manufacturing system, the system 200 may thus further comprise the above-mentioned various components known to a person skilled in the art for performing extrusion-based additive manufacturing. In such a case, for example, the at least one processor 204 may be communicatively coupled to the feeding mechanism and the print head movement mechanism (as well as any other mechanism(s) for controlling various other types of printing parameters, such as but not limited to, the nozzle size (e.g., nozzle diameter (ND)), the layer height (LH), the print speed (PS) and/or the extrusion temperature (eT)), for controlling them in the manner as described herein according to various embodiments.

In various embodiments, there is provided a porous structure fabricated according to the method 100 as described hereinbefore according to various embodiments of the present invention.

In various embodiments, the porous structure is a planar porous structure (at least substantially planar). In various embodiments, the plurality of pores are arranged to form one or more mechanical property varied portions of the porous structure, and the porous structure is configured to bend at the one or more mechanical property varied portions when heated above a predetermined temperature (e.g., when heated above the glass transition temperature of the material of the porous structure).

In various embodiments, the porous structure is manually deformable when heated above the predetermined temperature and becomes rigid with a deformed configuration according to the manual deformation when cooled below the predetermined temperature.

In various embodiments, the porous structure functions as an orthopedic cast manually deformable when heated above the predetermined temperature for encasing an object and becomes rigid with the deformed configuration when cooled below the predetermined temperature for restricting movement of the object. For example, in the case of the orthopedic cast being a finger brace, the finger brace is manually deformable when heated above the glass transition temperature of the material of the finger brace for encasing or wrapping around a finger and becomes rigid with the deformed configuration when cooled below the glass transition temperature for restricting movement (e.g., restricting bending) of the finger.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

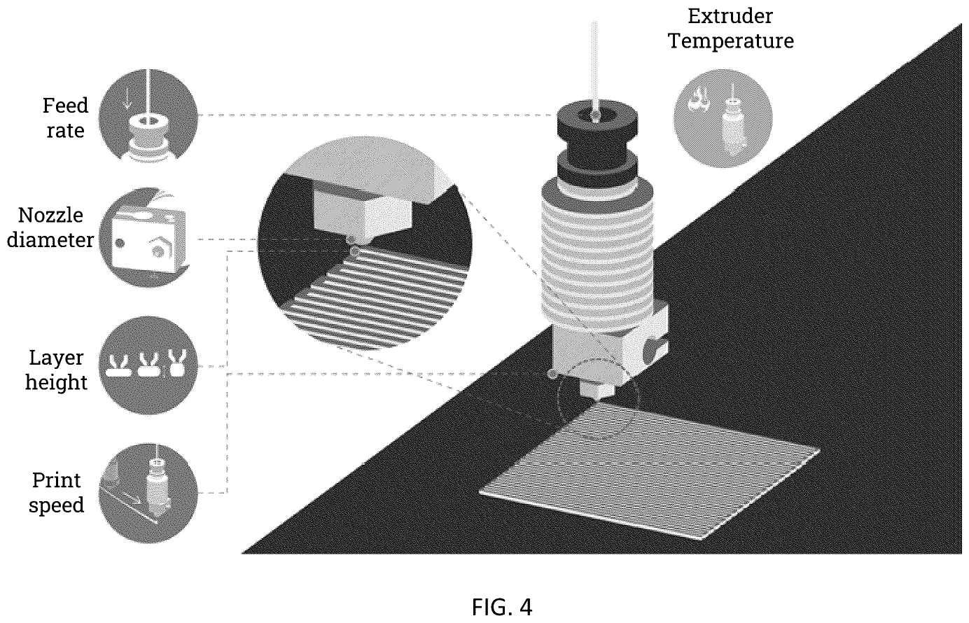

In particular, for better understanding of the present invention and without limitation or loss of generality, unless stated or the context requires otherwise, various example embodiments of the present invention will now be described with respect to the extrusion flow rate being controlled based on controlling the filament feed rate (or filament feed rate parameter) of the extruder of an FDM system for illustration purposes only. However, as explained hereinbefore, it will be appreciated by a person skilled in the art that the present invention not limited to any particular type of extrusion-based additive manufacturing system as long as the extrusion flow rate of the extruder of the extrusion-based additive manufacturing system is capable of being controlled (e.g., digitally controlled) as described herein according to various embodiments or example embodiments of the present invention. By way of an example only and without limitations, another other type of extrusion-based additive manufacturing system that is also be suitable for fabricating the porous structure may be Direct Ink Writing (DIW) of material prepared in paste form onto a substrate (without requiring any heating). For example, this may be performed with a pneumatic system (air pressurized) with the material loaded in a syringe, or the syringe may be directly compressed mechanically with a motor. Furthermore, the present invention is not limited to controlling only the feed rate for controlling the extrusion flow rate, and various other printing parameters may also be controlled in addition to controlling the feed rate according to various example embodiments of the present invention, such as but not limited to one or more of controlling a nozzle size (e.g., nozzle diameter) of the print head, controlling a layer height setting of the extruder, controlling a print speed of the print head and controlling an extrusion temperature of the extruder, such as illustrated in FIG. 4. In particular, FIG. 4 depicts a schematic drawing illustrating example print parameters which may be controlled or manipulated to control or manipulate the extrusion flow rate, including controlling a feed rate (i.e., material or filament feed rate (FR)) of the extruder for feeding a filament of the material to the print head, in combination with one or more of controlling a nozzle size (e.g., nozzle diameter (ND)) of the print head, controlling a layer height (LH) setting of the extruder, controlling a print speed (PS) of the print head and controlling an extrusion temperature (eT) of the extruder.

Various example embodiments provide extrusion-based additive manufacturing (AM) of porous structures by dynamically controlling the extrusion of materials (i.e., controlling the extrusion flow rate of the extruder). For example, this technology is applicable in materials design, device design and various fields requiring localized variation and customization of mechanical behaviours (e.g., corresponding to the one or more mechanical property varied portions as described hereinbefore according to various embodiments) within a fabricated structure (which may also be referred to as a printed structure). In this regard, according to various example embodiments, there is provided a method of fabricating porous structure by FDM printing (e.g., FDM 3D printing), as well as example applications for product design which may require post-modification of printed structures (e.g., reshaping or deforming the printed structures for various functions or purposes, such as to encase or wrap around an object).

In particular, various example embodiments enable the digital fabrication of porous (e.g., microporous) structures in two- and three-dimensions (2D and 3D), comprising a material (e.g., thermoplastic material) printed by FDM printing. In this regard, various example embodiments provide a computational tool that designs a FDM toolpath (which may also be referred to as a print path), which may vary depending on the required curvature of targeted area(s) in both 2D and 3D. In addition, the designed toolpath and the desired pore locations may be converted into a control file comprising control code (e.g., in the form of G-code)), which can then be readily used in commercial FDM printers to fabricate porous structures according to various example embodiments of the present invention, such as designing unique toolpath and extrusion profile. For example, various software known in the art may be used to employed, such as but not limited to, using Python language with RhinoGeometry SDK on built-in grasshopper scrip.

According to the method of fabricating a porous structure according to various embodiments, a variety of pore geometries may advantageously be constructed as negative spaces between extruded paths (i.e., a pore may be formed between two adjacent and opposing extruded material portions along two adjacent and opposing sections of the print path, respectively). In various example embodiments, for example, a variety of pore sizes and shapes may be formed by dynamically controlling (e.g., adjusting) the material extrusion flow rate (e.g., corresponding to dynamically controlling the filament feed rate) based on mathematical functions. Furthermore, the pores may advantageously be non-uniformly (or heterogeneously) distributed along 2D or 3D space within the printed structure. For example, a plurality of pores may be specifically arranged to form one or more mechanical property varied portions in the porous structure for facilitating bending or fracturing thereat. For example, the porous structure may thus be configured to bend (e.g., uniformly without breakage) at the one or more mechanical property varied portions (e.g., when heated above a predetermined temperature, such as the glass transition temperature of the material of the porous structure), so as to allow the porous structure (e.g., being hard or rigid when below the predetermined temperature) to encase or wrap around an object.

With the introduction of pores (e.g., micropores) in FDM-printed structures enabled by various example embodiments of the present invention, various mechanical property varied portions are able to be formed for various functional purposes, such as but not limited to, moving portions or parts, bending portions or parts, and fracture portions or points (or lines), using, for example, commercially available, low-cost FDM 3D printers, thereby advantageously enabling custom-design functional materials by additive manufacturing or 3D printing. For example, such fabricated structures can be used as prototypes of medical products (e.g., fingers, knees and wrist braces). In addition, the fabricated structures may serve as castable moulds (i.e., reshapeable structures when heated above the above-mentioned predetermined temperature), thereby enabling large scale production or manufacturing of structures with the desired geometry and pore configurations (e.g., size and location of pores).

In particular, various example embodiments advantageously provide the ability to control the material extrusion thickness. For example, pores arranged with thin material extrusion portions may function as hinge(s) that offer the reversible or flexible motion to the printed structure. In various example embodiments, by using soft and flexible shape-memory materials such as thermoplastic polyurethane (TPU), the bending angle (or bending range) of one or more mechanical property varied portions of a fabricated structure formed by a plurality of pores can be readily controlled or configured based on the material extrusion thickness and actuated by an application of heat (e.g., based on the glass transition temperature of the material forming the fabricated structure). Accordingly, various example embodiments advantageously open up new opportunities to design and fabricate thermoplastic-based functional structures. In various example embodiments, materials that are usable must be extrudable (e.g., TPU), and by various example embodiments may preferably use TPU due to the material's large change in clastic modulus above the glass transition temperature. However, it will be appreciated by a person skilled in the art that the present invention is not limited to the material used being TPU and other types of thermoplastic materials may be used as desired or as appropriate, such as but not limited to, polylactic acid (PLA), polycaprolactone (PCL) to polyethylene terephthalate glycol (PETG) just to name a few.

Accordingly, various example embodiments of the present invention provide a method of fabricating a porous structure based on extrusion-based additive manufacturing (e.g., by FDM 3D printing) and enable various applications for product design which may require post-modification of printed structures (e.g., reshaping or deforming the printed structures for various functions or purposes, such as to encase or wrap around an object).

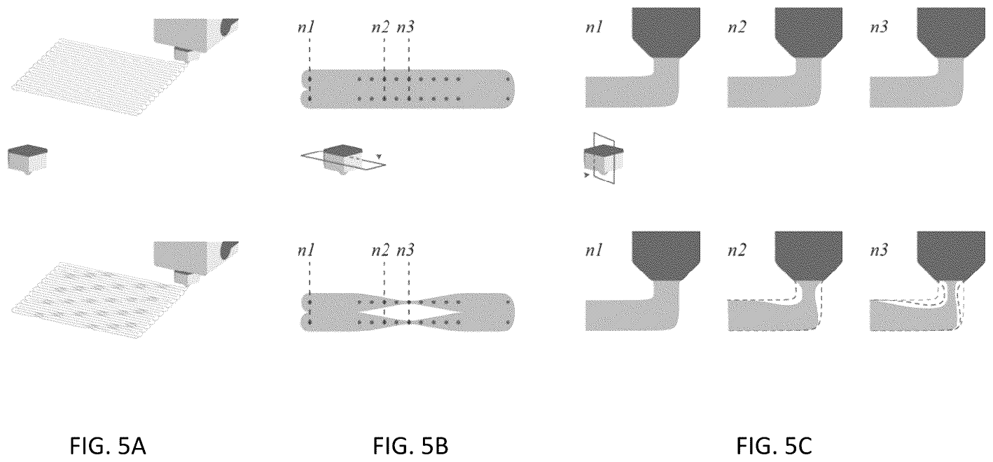

In particular, various example embodiments of the present invention provide a method of creating pores in FDM-printed structures. In this regard, various example embodiments provide both the printed structures (e.g., 2D or 3D printed objects) and the software that enables such additive manufacturing or printing (e.g., corresponding to the print head controlling module 206 and the extrusion flow rate controlling module 208 as described hereinbefore according to various embodiments). Advantageously, the digital fabrication of microporous constructs is embedded simultaneously during the geometry fabrication process of the porous structure without disrupting the print head movement. In this regard, the construction of pores as void spaces between two adjacent extruded material portions (e.g., extruded material lines) in the toolpath (i.e., between two adjacent and opposing extruded material portions along two adjacent and opposing sections of the print path, respectively) is based on varying or adjusting material extrusion flow rates. In this regard, a decreasing material flow facilitates the formation of a thin material extrusion, and thus, a plurality of thin extruded material portions may be formed, whereby each pair of adjacent and opposing extruded material portions are separated by a void space. By way of an example illustration, FIGS. 5A to 5C illustrate an example control of a material extrusion flow rate of the extruder for forming a pore according to various example embodiments of the present invention (bottom row of FIGS. 5A to 5C), compared to a conventional material extrusion with a fixed flow rate (top row of FIGS. 5A to 5C). In particular, FIG. 5A depicts a perspective view of a structure being formed based on extrusion-based additive manufacturing, FIG. 5B depicts a top view of two adjacent extruded material portions formed along two adjacent lines of a print path, and FIG. 5C depicts a schematic drawing illustrating a material extrusion flow from a print head of an extruder at three different positions (or extrusion nodes) (n1, n2 and n3) denoted in FIG. 5B. As can be seen, the control of the material extrusion flow rate according to various example embodiments enable the precise manipulation of material extrusion flow rate for fabricating porous structures with dynamic extrusion thickness instead of a fixed thickness. In particular, as shown, the dynamic variation of material extrusion flow rate according to various example embodiments enable the construction of a pore as a negative space between two adjacent extruded material portions (e.g., extruded material lines) in the toolpath (i.e., between two adjacent and opposing extruded material portions along two adjacent and opposing sections of the print path. These thinner extruded material portions are mechanically weaker, which may thus be configured for various functional purposes, such as but not limited to, bending hinges if the material used exhibits low elastic modulus or fracture portions or points (or lines) if the material used exhibits high elastic modulus. Accordingly, various example embodiments of the present invention advantageously enable customization or adjustment of material extrusion thickness at desired or selected portions or locations of the fabricated structure, which may be configured (e.g., aligned or distributed) along the 2D or 3D space within the fabricated structure for achieving various functional purposes.

In addition, as described above, various example embodiments enable various applications for product design which may require post-modification of printed structures (e.g., reshaping or deforming the printed structures for various functions or purposes, such as to encase or wrap around an object). For example, according to various example embodiments, by combining thermoplastics and uniquely designed pores, the printed structures can be uniquely bent, twisted or curved at intended or desired locations, thus enabling post-modification of printed structures. As an example, a heterogeneous or non-uniform distribution of the pore hinges can facilitate a graded variation of mechanical properties throughout the fabricated structure, thereby enabling guided formation of 3D structures from 2D printed structures. Using this principle, a variety of applications of product designs (e.g., finger braces) can be readily achieved according to various example embodiments of the present invention.

Accordingly, various example embodiments of the present invention advantageously enables a greater range of control in porosity design with no or minimally disrupted toolpath. For better understanding, the method of fabricating a porous structure based on extrusion-based additive manufacturing will now be described in further details according to various example embodiments of the present invention.

### Pore Construct

According to various example embodiments of the present invention, through extrusion-based additive manufacturing, the extrusion flow rate of material being extruded is adjusted along the toolpath (which may also be referred to as the print or traveling path). In this regard, lowering the extrusion flow rate decreases the extruded thickness of the material deposited on the print bed (which may also be referred to as the heat bed). In particular, when two adjacent and opposing extruded material portions along adjacent and opposing sections of the toolpath are configured or designed to be thinner extruded material portions, a gap or negative space is formed therebetween, thereby forming a single pore.

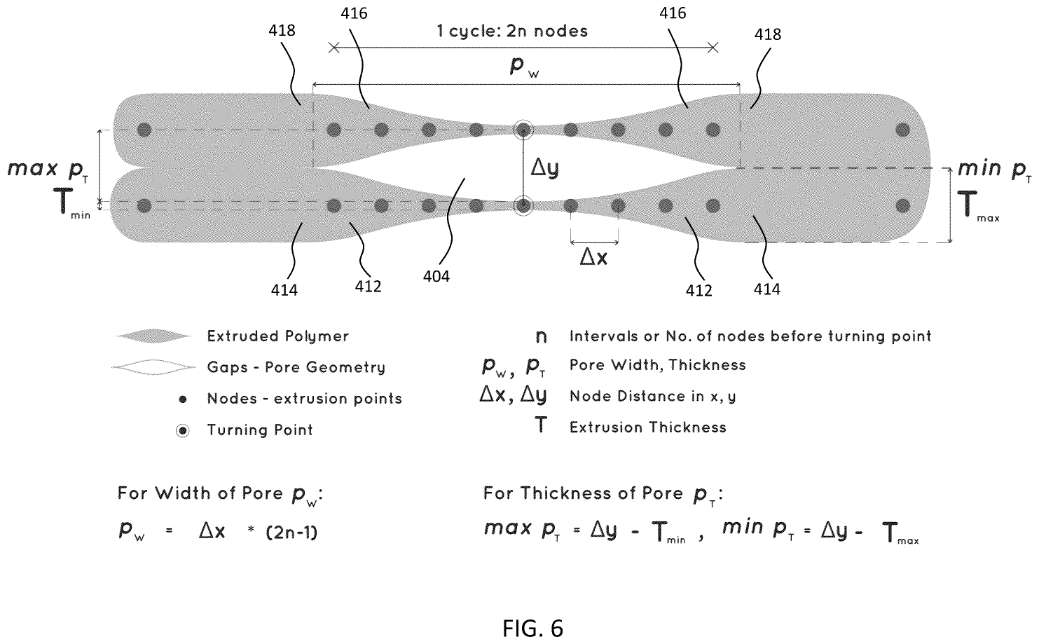

For illustration purposes, FIG. 6 depicts a schematic drawing of two example adjacent and opposing extruded material portions along two adjacent and opposing sections of the toolpath, respectively, configured to form an example pore 404 therebetween. In particular, FIG. 6 shows a first extruded material portion 412 formed along a first section (e.g., extending a length corresponding to the pore width) of the toolpath and a second extruded material portion 416 formed along a second section (e.g., extending a length corresponding to the pore width) of the toolpath, the second extruded material portion 416 formed being adjacent to and opposing the first extruded material portion 412 formed, such that a space is formed therebetween constituting a pore 404. In this regard, for forming the pore 404, the extrusion flow rate of the extruder is adjusted with respect to the first section of the print path to form the first extruded material portion 412, and the extrusion flow rate of the extruder is adjusted with respect to the second section of the print path to form the second extruded material portion 412. In various example embodiments, the extrusion flow rate is decreased with respect to the first section of the path to form the first extruded material portion 412 along the first section of the print path having a thickness less than an extruded material portion 414 formed along the print path immediately prior to and/or after (with respect to the printing direction) the first extruded material portion 412. Similarly, the extrusion flow rate is decreased with respect to the second section of the print path to form the second extruded material portion 416 along the second section of the print path having a thickness less than an extruded material portion 418 formed along the print path immediately prior to and/or after (with respect to the printing direction) the second extruded material portion 416.

In various example embodiments, for forming the pore 404, the extrusion flow rate (or extrusion flow rate value or parameter) is set (or controlled) with respect to a first plurality of positions (e.g., corresponding to the node points (or simply referred to as nodes) in the first section of the print path shown in FIG. 6) along the first section of the print path, and the feed rate is set (or controlled) with respect to a second plurality of positions (e.g., corresponding to the node points in the second section of the print path shown in FIG. 6) along the second section of the print path. As mentioned hereinbefore, for better understanding of the present invention and without limitation or loss of generality, unless stated or the context requires otherwise, various example embodiments of the present invention will now be described with respect to the extrusion flow rate being controlled based on controlling the filament feed rate (or filament feed rate parameter) of the extruder of an FDM system for illustration purposes only. Accordingly, in various example embodiments, controlling an extrusion flow rate corresponds to controlling the feed rate (or feed rate parameter). For example, the feed rate (FR) parameter may be defined by the length of filament fed into the melt zone (or print head) of the extruder per distance travelled by the extruder. Accordingly, decreasing the feed rate value with respect to a section of the print path between adjacent nodes translates to or results in thinning of the material extrusion along that section of the print path. Accordingly, various example embodiments advantageously manipulates or controls the material extrusion flow rate along the undisrupted toolpath to construct pores within the fabricated structure.

In various example embodiments, the decreasing of the feed rate with respect to a section of the print path for forming an extruded material portion along the section of the print path having a reduced thickness is performed based on a function having an output corresponding to the feed rate. Accordingly, in various example embodiments, a function is provided for controlling or determining the feed rate (e.g., corresponding to controlling or determining the material extrusion flow rate as described hereinbefore according to various embodiments). In various example embodiments, referring to FIG. 6, to form the pore 404, the feed rate is set (or controlled) with respect to a first plurality of positions (e.g., corresponding to the plurality of node points in the first section of the print path shown in FIG. 6) along the first section of the print path based on a first plurality of outputs of the function with respect to the first plurality of positions, respectively. Furthermore, the feed rate is set (or controlled) with respect to a second plurality of positions (e.g., corresponding to the plurality of node points in the second section of the print path shown in FIG. 6) along the second section of the print path based on a second plurality of outputs of the function with respect to the second plurality of positions, respectively.

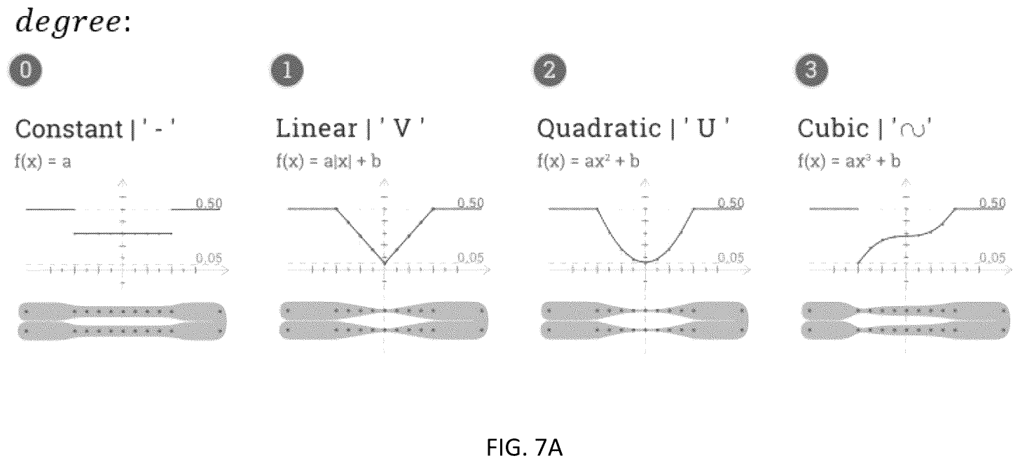

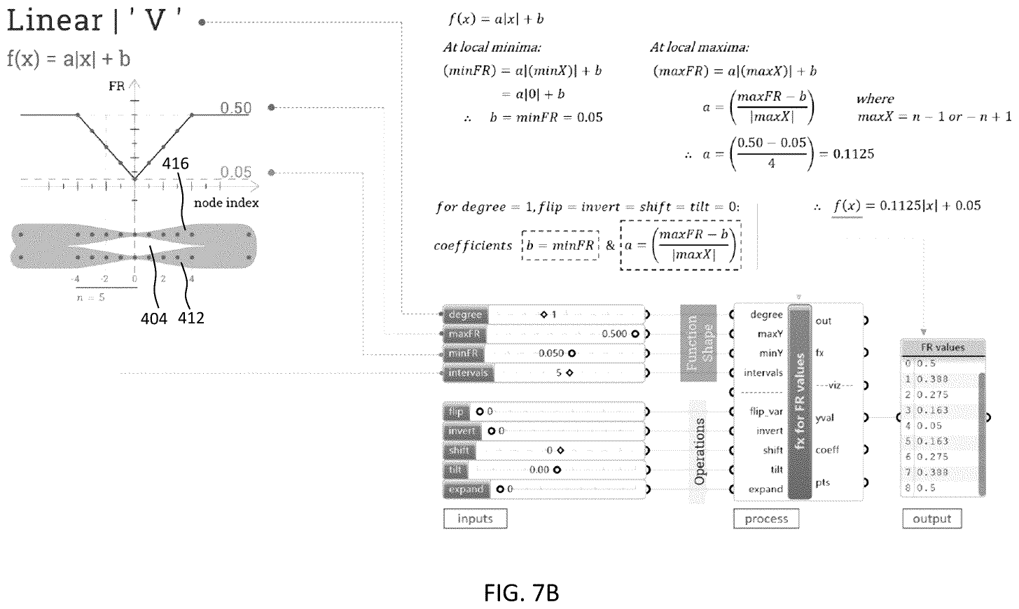

In various example embodiments, the function may be a polynomial function. By way of example only and without limitation, FIG. 7A illustrates various types of functions that may be applied for controlling or determining the feed rate according to various example embodiments of the present invention (e.g., corresponding to controlling the extrusion flow rate as described hereinbefore according to various embodiments), including a constant function ƒ(x)=a, a linear function ƒ(x)=a|x|+b, a quadratic function ƒ(x)=ax²+b and a cubic function ƒ(x)=ax³+b. It will be appreciated by a person skilled in the art that the present invention is not limited to any particular or specific type of function for controlling or determining the feed rate, as long as the function is able to provide an output corresponding to the feed rate with respect to a plurality of positions (or node points) along a section of the print path.

For better understanding and as an illustrative example only, an example case of the function being a linear function will now be described with reference to FIG. 7B according to various example embodiments of the present invention. In particular, FIG. 7B illustrates an example implementation or utilization of a linear function for controlling or determining the feed rate with respect to the first and second sections of the print path for forming a pore 404, and more particularly, for determining the feed rate with respect to each of the first plurality of positions (or node points) of the first section for forming the first extruded material portion 412 along the first section and for determining the feed rate with respect to each of the second plurality of positions (or node points) of the second section for forming the second extruded material portion 416 along the second section.

FIG. 7B illustrates a number of example parameters (e.g., input parameters) involved to configure the function for generating the pore 404, including a degree parameter for configuring a degree of the function (polynomial function), a maximum feed rate parameter for setting a maximum feed rate for the function, a minimum feed rate parameter for setting a minimum feed rate for the function, and an interval parameter for setting the number of positions (or node points) with respect to which the feed rate is to be determined using the function. For example, values for these example parameters may be inputted in range sliders for configuring the function as shown in FIG. 7B. Referring back to FIG. 7A, for example, the degree parameter indicates the degree of polynomial of the function for defining the profile shape of the pore 404 desired to be formed. In other words, the degree parameter may define the base function shape. For example, as shown in FIG. 7A, values of ‘0’, ‘1’, ‘2’ and ‘3’ for the degree parameter may correspond to a constant function, a linear function, a quadratic function and a cubic function, respectively.

Accordingly, in various example embodiments, the rate of change in the feed rate values across the nodes determines the rate of change of material extrusion flow, thereby controlling the change in the material extrusion thickness. For example, polynomial functions of different degrees (e.g., ranging from ‘0’ to ‘3’) control the rate of change of the feed rate by different orders, as illustrated in FIG. 7A. In the case of the example linear function with the degree being ‘1’ as shown in FIG. 7B, the feed rate varies linearly as a function of the node values, thus may indicate a fixed change of the feed rate from one node to the next node. For example, the polynomial function may be expressed in the form of ƒ(x)=a|x|+b for generating the feed rate value at each node as an output, as illustrated in FIG. 7B. For example, in the example linear function, the coefficient ‘b’ is the minimum feed rate (minFR) at the central node and the coefficient ‘a’ is the gradient (i.e., rate of change) of the function. In various example embodiments, the gradient is configured to ensure that all the feed rate values do not exceed a range of values that would result in discontinuous extrusion due to low feed rate or build-up of internal pressure within the print head (or more particularly, the nozzle) due to excess filament feeding with a high feed rate. Therefore, in various example embodiments, the function expression is configured according to a maximum feed rate (maxFR) and a minimum feed rate (minFR) provided by the maximum feed rate parameter and the minimum feed rate parameter, respectively. The interval parameter translates to the number of nodes in a section (e.g., in each of the above-mentioned first and second sections) of the toolpath used for generating the pore 404. In the example linear function, the interval parameter has an example value of 5 (i.e., n=5), which may refer to the node index of the central node in the section, that is, there are five nodes from the central node to an end node (inclusively) at either end of the section. Accordingly, the total number of nodes in the section of the toolpath to form the pore 404 may be determined by a formula 2n−1, which is 9 nodes for the example of n=5. The feed rate at each of the 9 nodes may thus be determined using the example linear function for forming the extruded material portion along the section of the toolpath. FIG. 7B also illustrates example computations of the coefficient values (‘a’ and ‘b’) for the example linear function based in the input parameters.

Accordingly, an example implementation of a linear function for determining the feed rate with respect to the first and second sections of the print path for forming a pore has been described with reference to FIG. 7B for better understanding and for illustration purposes only. It will be appreciated by a person skilled in the art that the present invention is not limited to the specific values used in the example implementation of the linear function, which are for illustration purposes only. It will also be appreciated by a person skilled in the art that other types of functions, such as those shown in FIG. 7A, may also be implemented for determining the feed rate for forming a pore in a similar or corresponding manner as desired or as appropriate, and it is not necessary to describe the corresponding implementation with respect to each other type of function herein for clarity and conciseness.

### Pore Geometries

In various example embodiments, there is provided a further example parameter (input parameter) for configuring the function for generating the pore 404, namely, an operation parameter for indicating or defining a type of operation for subjecting the function (or the base function) to. In various example embodiments, the type of operation may be categorized into two groups, such as a transform (or transformational) category and a translate (or translational) category. For example, a transformational operation may alter the whole function shape, whereas a translational operation may only adjust certain part(s) of the function. For example, the transform category may include a flip operation (e.g., denoted as +flip) and an invert operation (e.g., denoted as +invert), and the translate category may include a tilt operation (e.g., denoted as +tilt), a shift operation (e.g., denoted as +shift) and an expand operation (denoted as +expand). For example, these operations facilitate the manipulation or modification of the function (or the base function) for enabling the formation of a variety of additional profile shapes of the pore 404 (or a variety of additional pore geometries). For example, the resultant function may control the feed rate in such a manner that enables the construction of an asymmetrical pore.

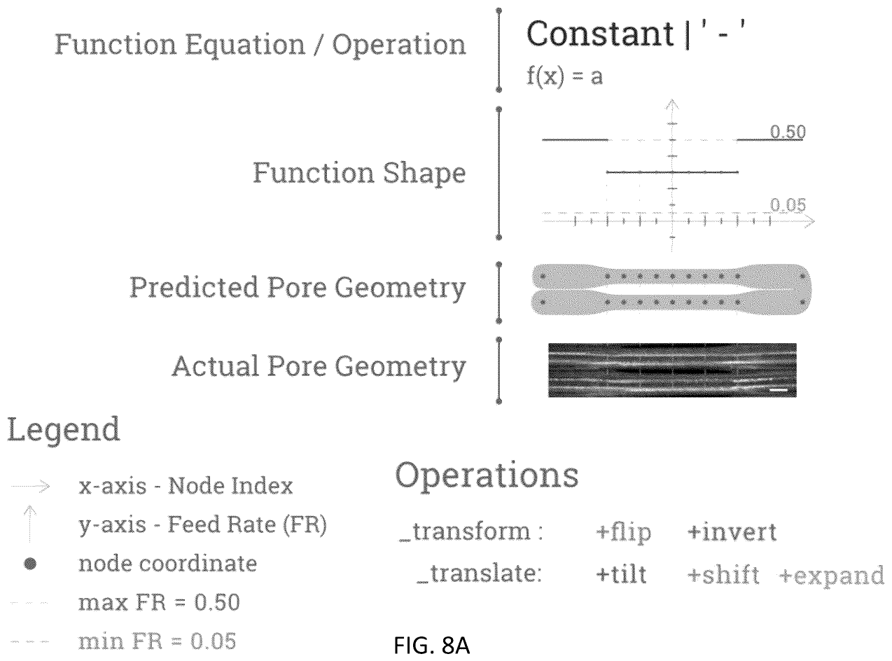

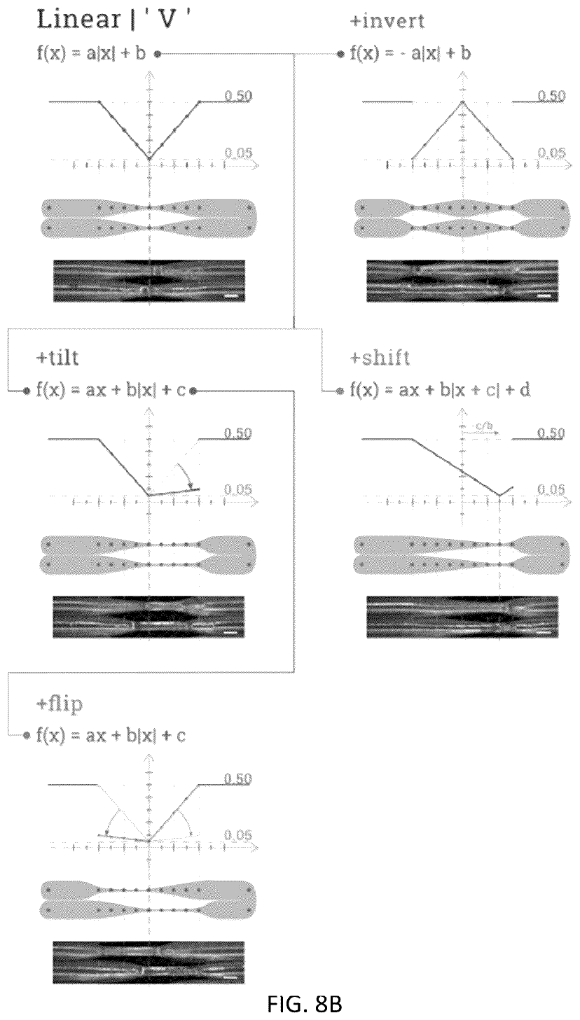

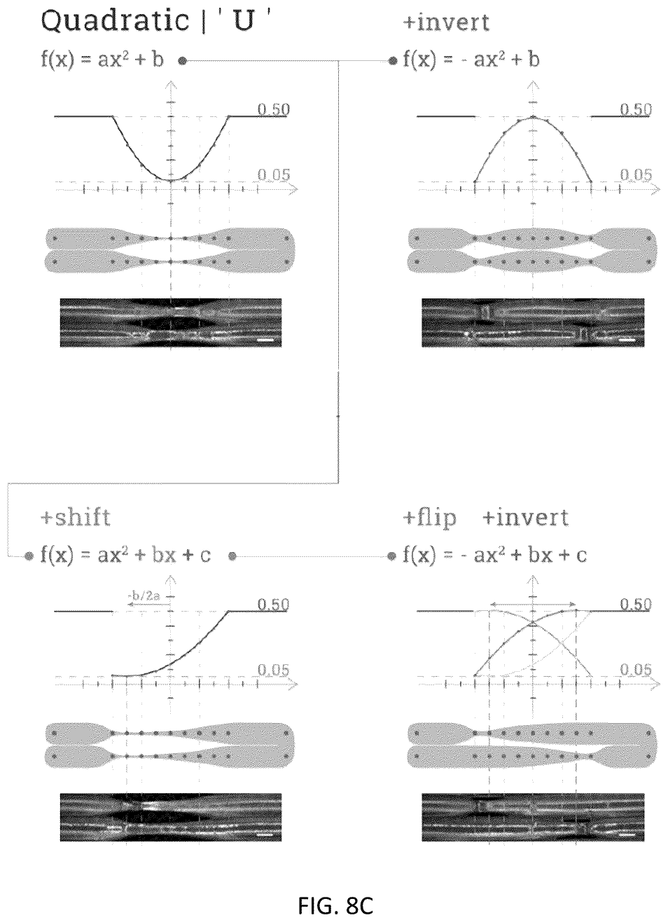

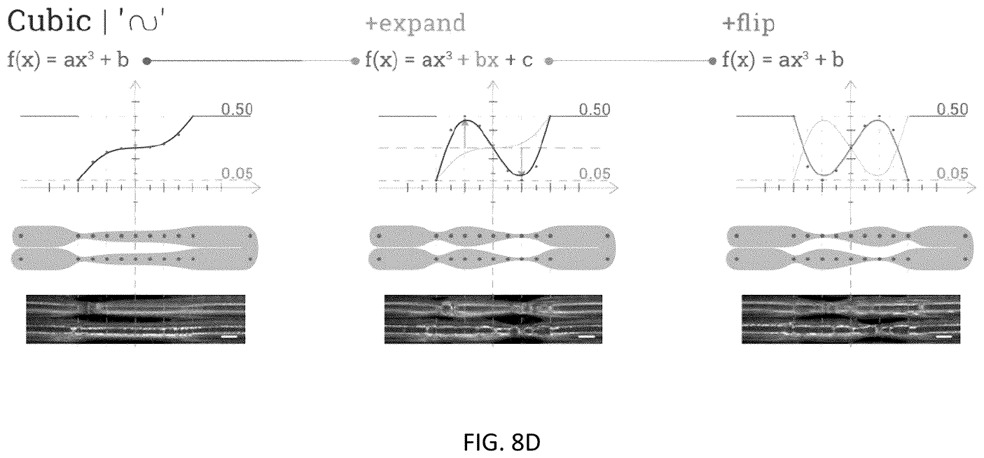

For illustration purpose and by way of examples only, FIGS. 8A to 8D illustrate the effects of various operations applied to different types of functions for forming a variety of pore geometries, including symmetrical pores and asymmetrical pores, according to various example embodiments of the present invention.

Accordingly, various example embodiments advantageously provide a parametric framework for forming pores in a porous structure. In various example embodiments, in addition to the feed rate, one or more other printing parameters may also be dynamically controlled or varied with respect to the nodes in a section (e.g., in each of the above-mentioned first and second sections) of the toolpath together with the feed rate, such as but not limited to, a print speed (PS), a layer height (LH), an extruder temperature (el) and a heat bed temperature (hT).

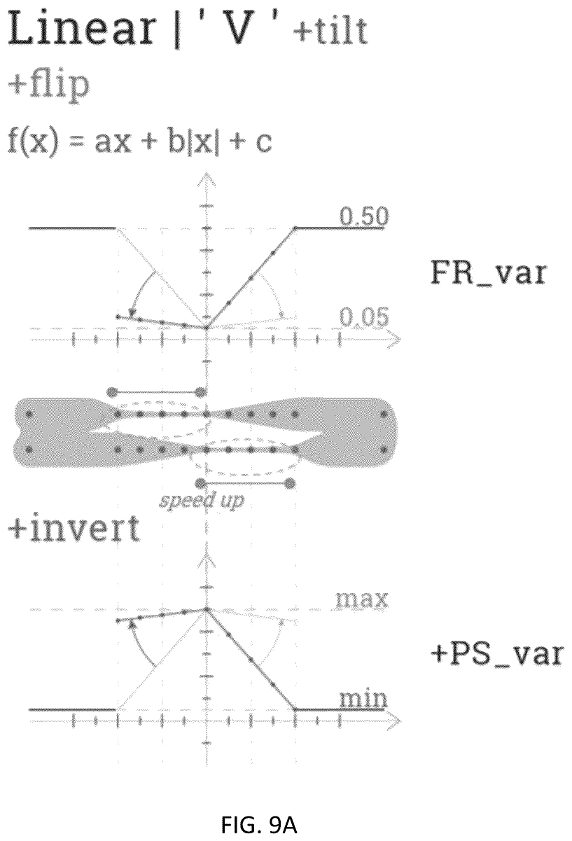

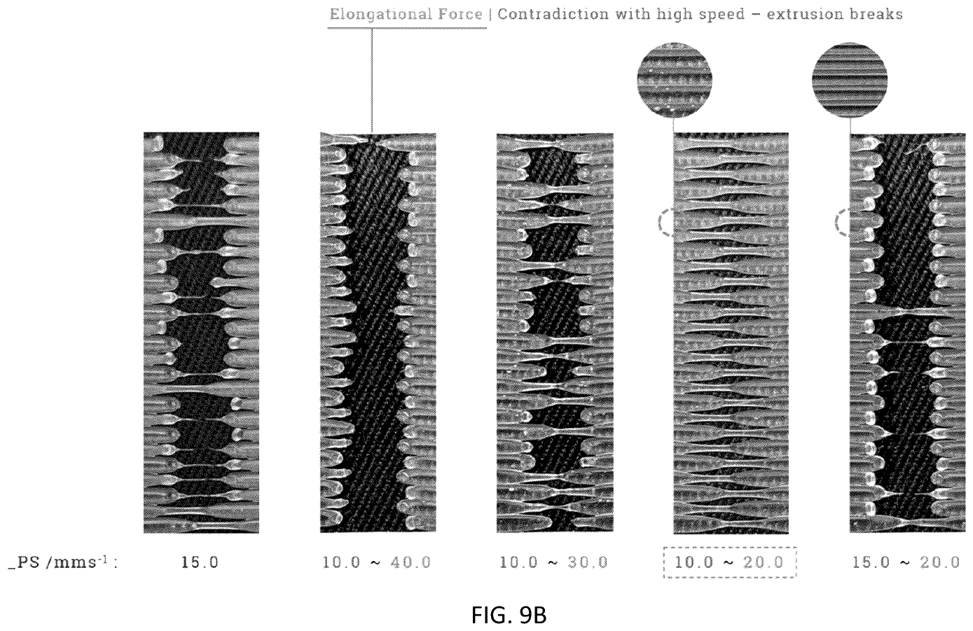

For illustration purpose and by way of an example only, FIG. 9A illustrates an example implementation of a linear function for controlling or determining the feed rate with respect to the first and second sections of the print path for forming a pore, as well as simultaneously controlling or determining the print speed with respect to the first and second sections based on the linear function, for addressing a potential issue relating to discontinuous material extrusion. In particular, as shown in FIG. 9A, for each node in the first and second sections of the toolpath, the print speed with respect to the node is controlled so as to have an inverse relationship to the feed rate determined with respect to the node, for example, by subjecting the linear function for controlling the feed rate to an invert operation so as to obtain an inverted function. Accordingly, the print speed of the print head may be controlled based on an inverse of the function for controlling the feed rate of the extruder. In this regard, various example embodiments identified that discontinuous material extrusion may occur due to consecutive nodes of insufficient feed rate. Accordingly, in various example embodiments, the print speed of the extruder is additionally controlled or varied to address such a potential issue relating to discontinuous material extrusion. In various example embodiments, one or more functions may be configured to provide one or more outputs corresponding to one or more other printing parameters in a similar or corresponding manner or in a manner as desired or appropriate, such as but not limited to for the nozzle size (e.g., nozzle diameter (ND)), the layer height (LH), the print speed (PS) and/or the extrusion temperature (eT).

FIG. 9B shows pictures of extruded material portions formed at different print speeds for illustrating the potential issue relating to discontinuous material extrusion. For example, FIG. 9B shows the emergence of discontinuous extruded material portions formed, such as when a linear function was used to control the feed rate together with a combination of tilt and flip operations. In this regard, as shown, the tilt operation may result in an issue whereby consecutive nodes of low feed rate resulted in extruded material portions breaking due to the gentle slope on one half of the variation. In various example embodiments, to address such a discontinuation, an original or fixed print speed (e.g., 15.0 mm/s) may be increased to speed up the material extrusion. Through this acceleration, the molten material may then be stretched due to its low elastic modulus. In various example embodiments, as illustrated in FIG. 9A, to facilitate a continuous material extrusion, the print speed of the extruder was varied dynamically throughout the nodes in a section based on the same parameter inputs as provided for controlling the feed rate, but with an additional invert operation. Such a dynamical variation of the print speed resulted in a higher print speed for lower feed rate values to overcome the above-described potential issue relating to discontinuous material extrusion. FIG. 9B also illustrates the iteration performed for determining or tuning the maximum print speed value (maxPS) and the minimum print speed value (minPS). In this example, an optimal range of print speed values was determined to be from about 10 mm/s to about 20 mm/s.

### Pore Dimensions

The thickness of extruded material portions has an impact on bending and fracture tolerance. In this regard, to determine a range of bending and fracture, various example embodiments seek to deduce the maximum obtainable range of dimensions for the pores. In this regard, the dimensions were characterized by measuring pore thickness and pore width. As shown in FIG. 6, the pore thickness (pT) may be defined as the distance that the negative space spans, perpendicular to the extrusion direction (i.e., Py). Since it is perpendicular, it is constrained by the maximum extrusion thickness that the nozzle aperture can allow. Hence, there are maximum and minimum values of achievable pore thickness.

For illustration purposes, symmetrical pore geometries were used to ensure consistency of measurements and comparison. In particular, amongst the functions that generate symmetrical pores, the basic quadratic function (ƒ(x)=ax²+b) was selected over the basic linear function for feed rate variation, whereby for the former, the nodes around the central node have slightly lower feed rate values than the latter.

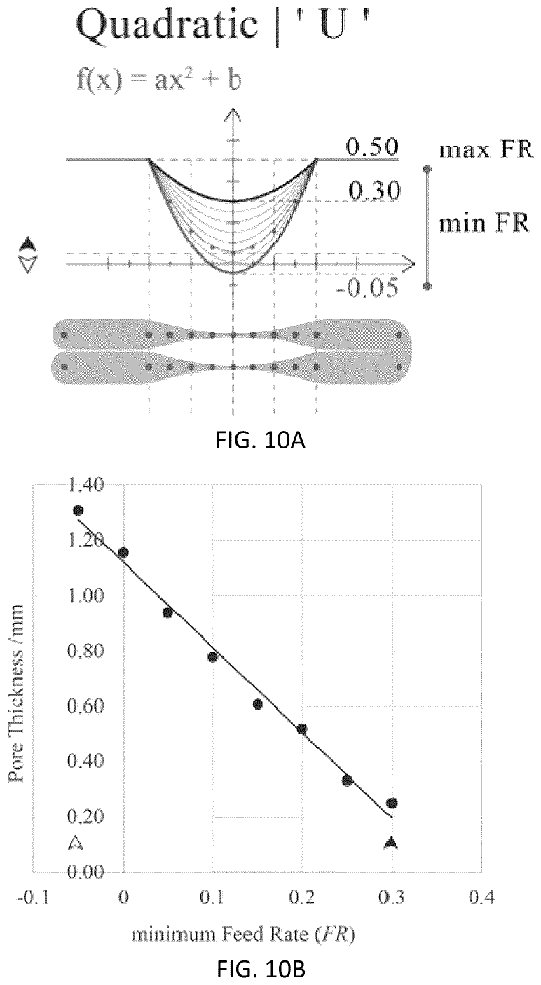

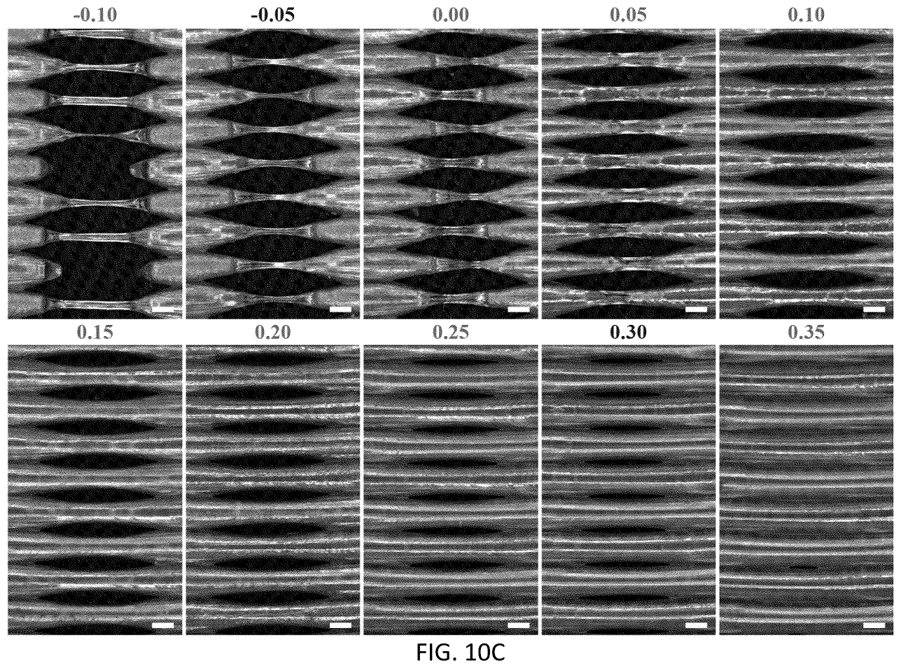

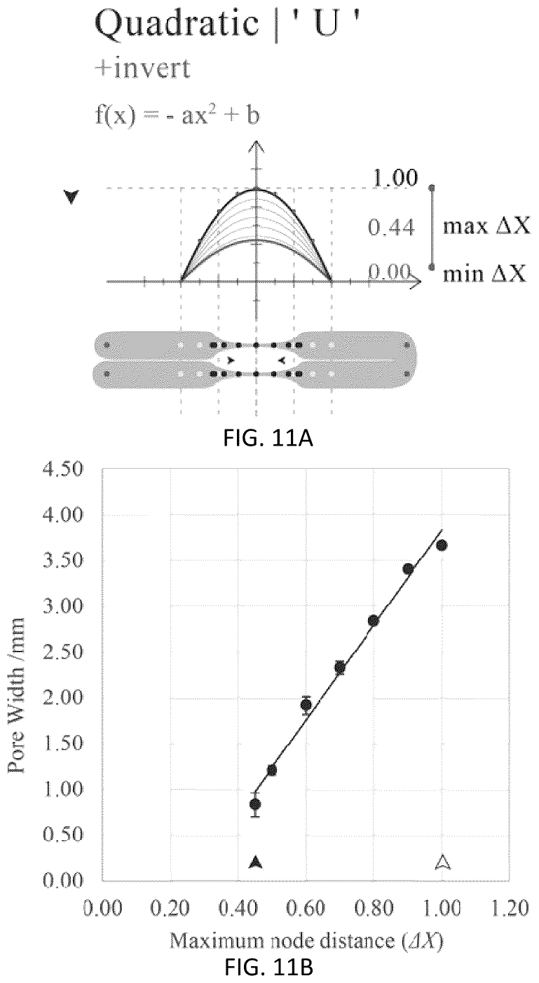

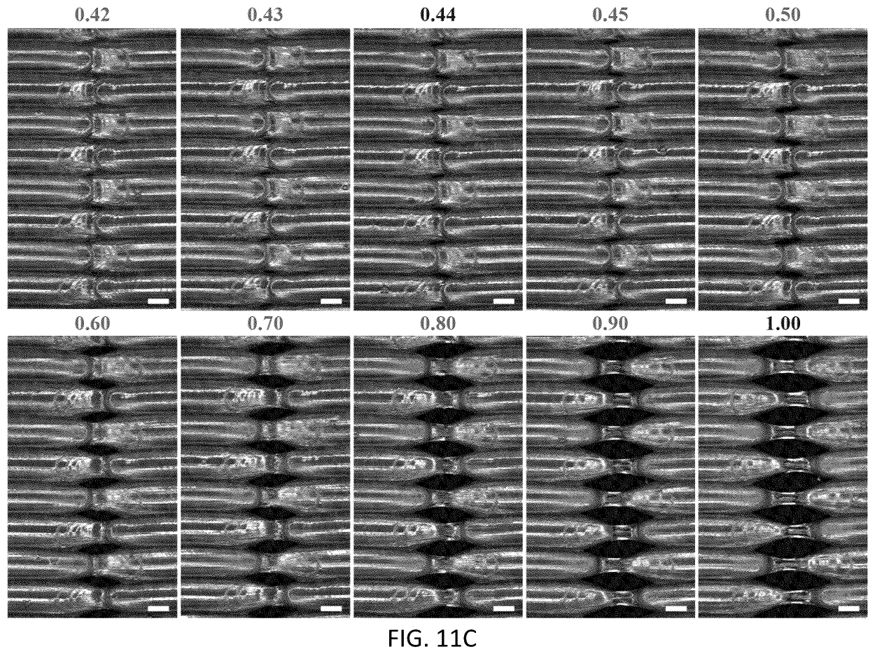

FIG. 10A illustrates an example implementation of the quadratic function for forming a pore whereby the minimum feed rate (minFR) was gradually varied, according to various example embodiments of the present invention, FIG. 10B depicts a plot thereof illustrating the substantially linearly proportional relationship between the pore thickness measurements and the corresponding minimum feed rate values (minFR). In various example embodiments, to measure achievable pore thickness, the minimum feed rate parameter was gradually varied to change the minimum extrusion thickness of the pore geometry, while keeping other variables constant. The minimum pore thickness (min pT) was obtained by gradually increasing the minimum feed rate (minFR) until the negative space disappears. The maximum pore thickness (max pT) was obtained by gradually decreasing the minimum feed rate until the pore no longer holds its shape (i.e., the material extrusion is discontinued). FIG. 10C shows the corresponding incremental pore thickness measurements from min pT=about 250 μm to max pT=about 1300 μm at minFR=−0.05 to minFR=0.30, respectively, along with pictures of corresponding individual pores captured under microscope. FIG. 11C also illustrates the consistency of pore construct for each minFR value.

As shown in FIG. 6, the pore width (P_{w}) may be defined as the length or distance that the negative space spans parallel to the extrusion direction. Unlike the pore thickness, the pore width can be as wide as the extrusion travels, for example, depending on the number of nodes in two adjacent and opposing sections of the toolpath for forming the pore. Therefore, various example embodiments seek to identify the minimum achievable pore width.

FIG. 11A illustrate an example implementation of the quadratic function for forming a pore whereby the positions of nodes in each of the two adjacent and opposing sections of the toolpath for forming the pore were varied (ΔX), according to various example embodiments of the present invention, and FIG. 11B depicts a plot thereof illustrating the substantially linearly proportional relationship between the pore width measurements and the corresponding maximum node separation distance values (maxΔX). In particular, instead of varying minFR for the measurements, the positions of nodes were varied. In this regard, ΔX variation was introduced to vary the distance between each pair of neighbouring nodes in each of the two adjacent and opposing sections. As shown in FIG. 11A, the same quadratic function was used to obtain the symmetrical pore, but with an invert operation. The invert operation brings the further nodes closer to the central node by gradually decreasing maxΔX values. With this ΔX variation, a min P_{w} of about 850 μm was achieved at maxΔX of 0.44 mm. FIG. 11C shows the incremental pore width measurements from maxΔX=0.42 mm to maxΔX=1.00 mm, along with pictures of corresponding individual pores captured under microscope. FIG. 11C also illustrates the consistency of pore construct for each maxΔX value.

### Pore Distribution

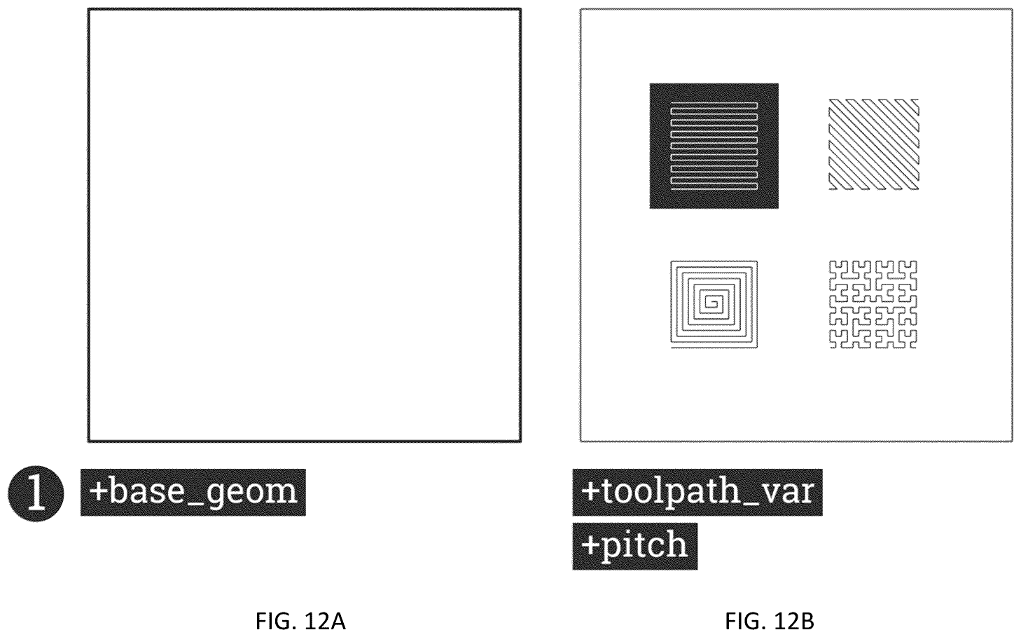

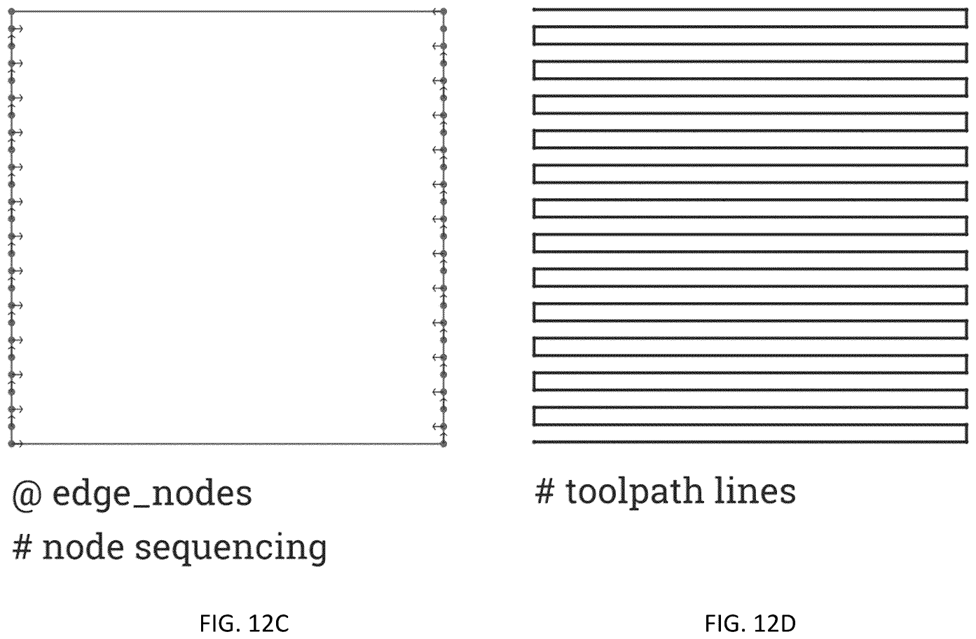

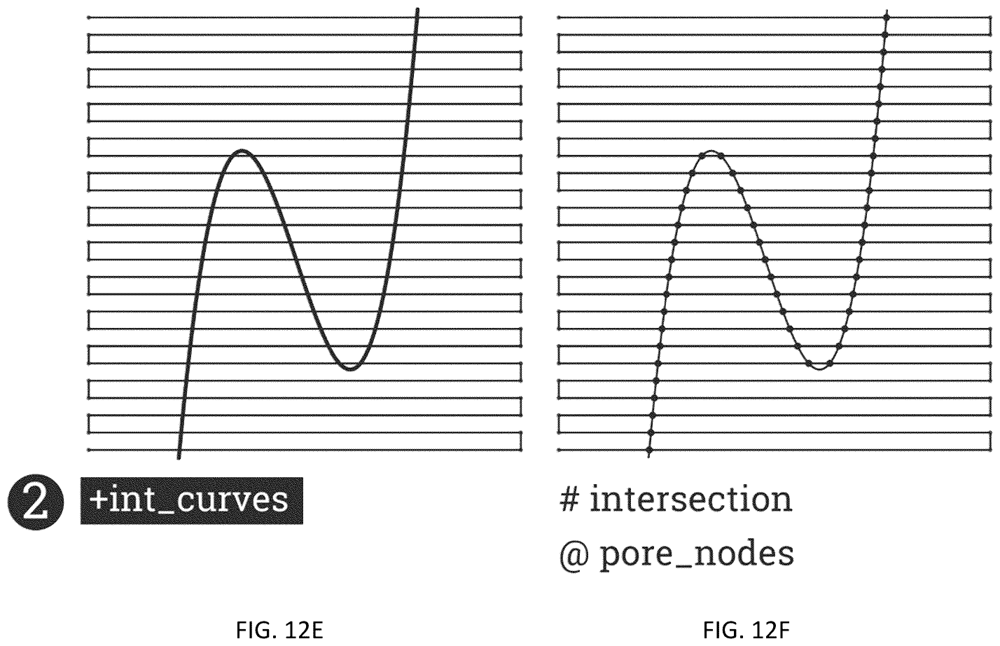

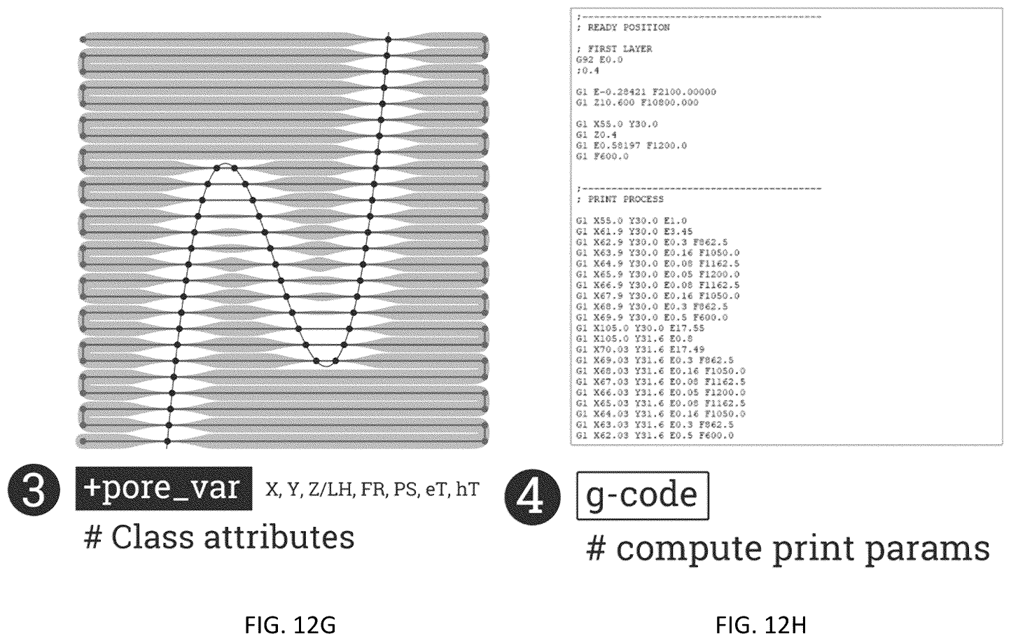

To demonstrate the effect of the pore hinges on the fabricated structure, a technique is provided for arranging or distributing a plurality of pores in the 2D or 3D space of the fabricated structure. Accordingly, with various spatial distributions of the pores, fabricated structures are granted tunable mechanical properties at specific or desired locations to facilitate bending actuations. FIGS. 12A to 12H depict an example technique or workflow for arranging or configuring a plurality of pores to form a mechanical property varied portion at specific or desired locations within the fabricated structure, according to various example embodiments of the present invention. Such a pore distribution framework may be based on a sample base geometry for defining the toolpath and an input curve for defining the desired locations or distribution of the pores. In particular, as illustrated in FIGS. 12A to 12H, the workflow may include four main steps: (1) base toolpath generation, (2) pore location identification, (3) pore geometry generation, and (4) G-code generation based on the attributed data along with a visual illustration for inspection before printing. For example, in FIGS. 12F and 12G, pore nodes are represented by solid black dots. These pore nodes refer to parts of the geometry of the structure to be formed that require at least a line of instruction for the 3D printer to execute in order to achieve the intended effect (i.e., the intended mechanical property varied portion(s)). The example workflow shown in FIGS. 12A to 12H illustrates the generation of these nodes, including various specific example parameters utilized. Up to FIG. 12D, it is understood that the toolpath of the print head movement has been configured and executed at each edge node shown in in FIG. 12C. FIG. 12E describes the user input of a curve of a form (e.g., as selected by the user) to represent the distribution of pores in the structure to be formed. FIG. 12F describes the generation of pore nodes as intersections between the toolpath lines and the input curve. As shown in FIG. 12G, these pore nodes are characterized with variables to vary the feed rate (FR) as described hereinbefore according to various example embodiments to generate the dynamic or desired changes in extrusion thickness. In various example embodiments, the parameters that each node is characterized with may include: X, Y, Z (being the 3D coordinates of the pore node with respect to the print bed dimensions), where Z is synonymous with the layer height (LH) (i.e., height of the print head's nozzle at the corresponding layer); feed rate (FR) which refers to the rate of material feed); print speed (PS) which refers to the speed of nozzle movement during extrusion; extruder temperature (el) and heat bed temperature (hT).

### Product Designs

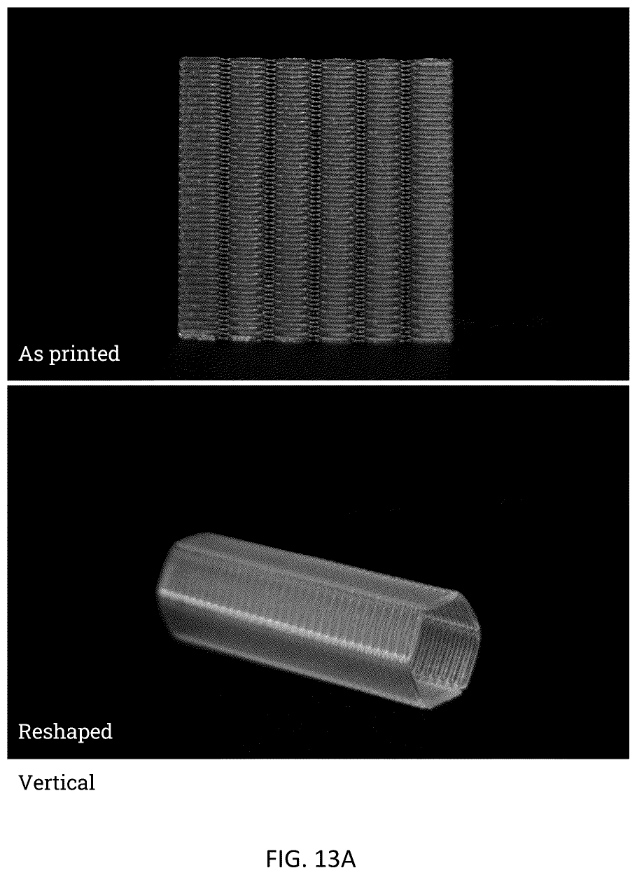

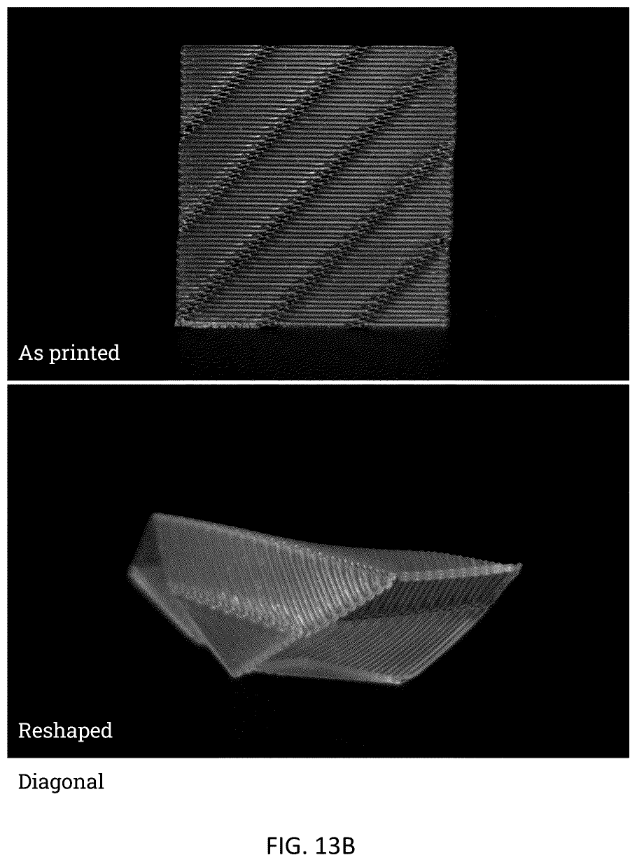

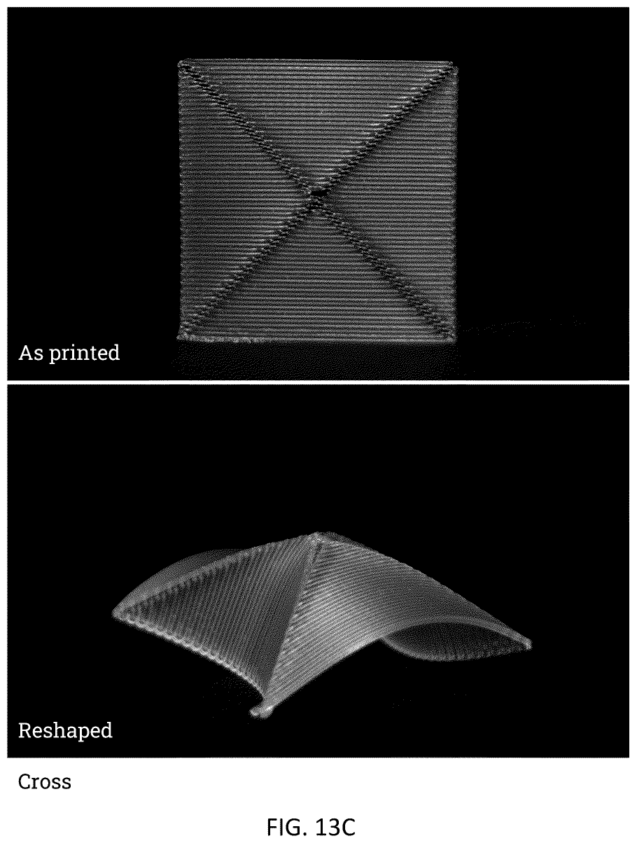

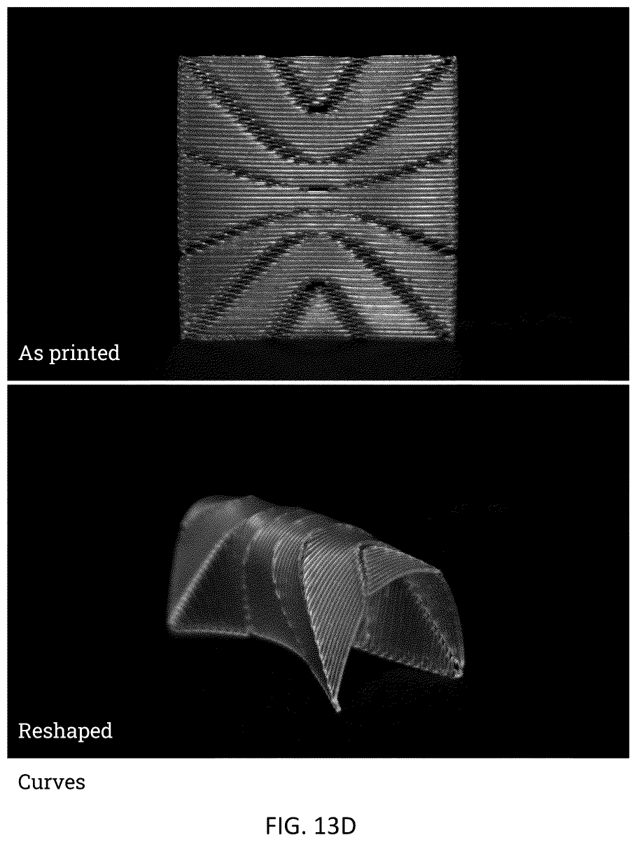

Using the method of fabricating a porous structure as described hereinbefore according to various example embodiments, as well as the particular arrangement of a plurality of pores to form one or more mechanical property varied portions at specific or desired locations of the printed structure for controlling the mechanical property thereof, the printed structure can be formed to be a foldable or deformable 2D thermoplastic sheet that may be converted or reshaped to a 3D structure, which is for example applicable to design industrial and medical products. For illustration purposes and by way of examples only, FIGS. 13A to 13D illustrate four two-layered planar printed structures with different distributions of pores, namely, vertical, diagonal, cross and curve arrangements or distributions, along with their reshaped 3D structures. In particular, to demonstrate the effect of various distributions of pore hinges according to various example embodiments of the present invention, four different distributions within two-layered planar printed structures (two-layered square sheets) of the same dimensions were fabricated. The material used was a heat-sensitive shape memory polymer (SMP) filament made of thermoplastic polyurethane (TPU). In this regard, SMP exhibits a wide range of elastic modulus at different temperature. Below the glass transition temperature (T_{g}), which is 55° C. for such a filament, the material is in a glassy or rigid state with high elastic modulus. Above the T_{g} and below the melting temperature, the material is in a rubbery state with low elastic modulus, and is subjected to high degrees of deformation with a maximum strain up to 400%. Utilizing the shape memory behaviour, according to various example embodiments, the printed structures were first heated to, for example, 70° C. (i.e., above the Tg). Each printed structure was then reshaped and held in the reshaped position as it cools upon removal of the heat source. After the temperature of the printed structures settles at room temperature (i.e., below the Tg), the printed structures became rigid with the deformed shape or configuration.

For example, prior to the application of heat, the alignment of pore hinges served as elastic bending points or portions where the structure could fold along. The folding along the pores is demonstrated in the vertical and diagonal arrangements in the printed structures achieved shown in FIGS. 13A and 13B. These reshaped 3D structures are possible since the pore alignment did not intersect. For the cross arrangement, however, the pores are distributed to form a cross intersection, and thus, the printed structure could only fold along each diagonal edge at one time prior to the application of heat. For example, in a single fold, only one diagonal edge (from one corner of the square to the other corner) can bend, and the other diagonal edge cannot bend due to resistive forces from the bent structure. For the curve arrangement shown in FIG. 13D, a set of curves were mirrored along both middle axes, and the printed structure could not fold along the pore hinges prior to the application of heat. In FIGS. 13A to 13D, the bottom image illustrates the corresponding structure that have been reshaped into corresponding 3D structures after the material has been softened upon the application of heat above Tg. Without being softened, i.e., in its rigid state, for example, the structure in FIG. 13D cannot be deformed or bent.

With the application of heat above Tg, the softened material may then be deformed or reshaped. Upon cooling down in the deformed shape or configuration, the material becomes rigid and arrests the structure governed by the pore hinges. For example, for the cross arrangement, as illustrated in FIG. 13C, the rigid 3D structure obtained after deforming demonstrated two opposing curvatures on alternate quarters segmented by the pores. For the curves arrangement shown in FIG. 13D, the pore hinges split each extrusion line (e.g., each horizontal line of the fabricated structure shown in FIG. 13D) into various number of segments (corresponding to non-mechanical property varied portions). For example, at the center of the structure (extrusion lines around the center of the structure), no pores exist; towards the top and bottom edges, certain extrusion lines have three segments (of non-mechanical property varied portions) and certain other extrusion lines have five segments (of non-mechanical property varied portions). In this regard, since the center of the structure has no pores, the span of the extrusion is the longest compared to the rest of the structure. The distributed segments results in a large curvature at the center of the deformed structure with decreasing curvature towards the above-mentioned top and bottom edges.

Accordingly, with SMP filaments, the fabricated structures become soft above the Tg and can be deformed or reshaped into different 3D configurations. For example, the pores may subdivide extrusions into smaller segments, allowing them to bend in various curvatures and even in opposing directions within the same structure. The structures become rigid once it cools below Tg and is arrested in the deformed configuration. Accordingly, the pores may be uniquely configured for the desired structure and can be adapted to any targeted surfaces (e.g., finger, elbow, wrist, knee). For example, the reversible shape morphing structures may be printed as flat sheets, which facilitates the case of transport and storage. With the application of heat, the structures can be morphed into required shapes that are guided by the incorporated porosity design.

### Finger Brace

To demonstrate the practical application of the method of fabricating a porous structure according to various example embodiments of the present invention, by way of an example only and without limitation, a planar printed structure of thermoplastic polyurethane (TPU) was fabricated that can be reshaped to form a 3D finger brace.

Conventionally, orthopedic casts (e.g., made of Plaster of Paris (POP) or fiberglass (FG)) are designed to immobilize bones for soft tissue recovery during the treatment of injuries such as bone fractures. This decade-long unchanged treatment has been proven reliable although it has introduced multiple problems to many users. For example, patients undergo many disruptions to their daily activities because the cast is bulky, uncomfortable, not waterproof and lack ventilation. In addition, medical personnel are faced with their own array of issues regarding the application and removal of the cast, as well as monitoring of the recovery process. Conventional casts require multiple steps, tools and materials for the application and removal of the casts, and the process can be messy as well. For example, the fully enclosed structure due to moulding of the POP or FG may introduce potential issue due to cast misfit. This problem is frequently encountered during the recovery process because swelling of the injured site may subside over time. Compartmental complications on the skin may also arise and the lack of visibility may delay appropriate medical attention.

3D printed thermoplastics are lightweight, waterproof and can be customized for ventilation. Casts can also be designed with an increase in visibility for case of monitoring. However, the customized fabrication of 3D printed structures may introduce an array of other issues related to manufacturing, such as measurements required for precise geometry generation, or the time taken to print and post-process the parts. However, these issues are mitigated or overcome according to various example embodiments of the present invention as the structure is printed planar (i.e., in 2D), which may then be deformed or reshaped into a 3D structure to fit the shape of the site or object of interest.

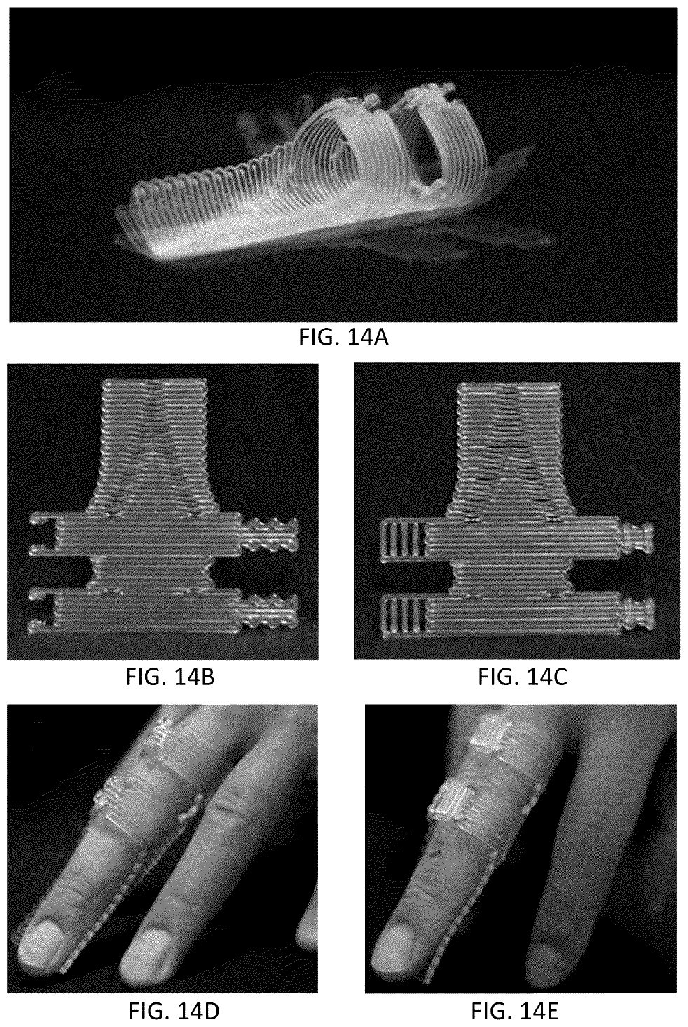

FIGS. 14A to 14E depict pictures of an example finger brace fabricated according to various example embodiments of the present invention. As shown in FIGS. 14B and 14C, the finger brace structure is printed flat or planar according to the method of fabricating a porous structure according to various example embodiments of the present invention. With the application of heat, the flat printed structure softened for deforming or reshaping, and it may be folded with various curvatures along the pore hinges to support the finger up to the tip. Additional fastening joints may also be printed to enable locking of edge portions configured to meet after bending. Upon cooling, the printed structure stiffens with the locked structure, thus immobilizing the finger as shown in FIGS. 14D and 14E. For example, the fastening joints may be designed with adjustable sizes by introducing different locking positions (e.g., equally spaced). Accordingly, various example embodiments of the present invention advantageously overcomes key problems associated with conventional casts. Firstly, size changes over time due to the swelling subsiding of the fracture site, resulting in a poor fit of the conventional casts that destabilizes the immobilization. Secondly, direct 3D printed casts with fixed geometries have to be customized for different patients, adding unnecessary and undesirable steps in the operational workflow. In contrast, various example embodiments advantageously provide a functionally graded 2D structure that can bend at controlled angles upon application of heat and manual shaping to achieve a rigid 3D structure when cooled. In addition, fastening joints may be provided to lock edge portions configured to meet after being bent in place, such as but not limited to, clipping mechanism as shown in FIGS. 14C and 14E or snapping mechanism as shown in FIGS. 14B and 14D.

Accordingly, graded variations of porosity throughout a fabricated structure grants dynamic changes in material property for unique functional requirements. To achieve this functional grading, for example, multi-material 3D printing (MM3DP) may also strategically distribute a graded range of material composition throughout the printed structure. However, these MM3DP techniques face a number of technical challenges, such as (1) production speed is compromised due to multiple machine movements required to swap materials, (2) weak interfacial bonding due to disparate materials used, and (3) complex distribution of heterogeneous materials within the manufactured structure gives rise to difficulties with recycling at the end of the product life cycle.

In contrast, various example embodiments of the present invention achieve functionally graded structures of dynamic porosity with a single material through a single-step approach. In particular, the print toolpath is not disrupted as pores are introduced when the material flow is digitally altered at precise locations. Furthermore, as illustrated in FIG. 12F, curve intersections facilitate the precise distribution of pores in the structure. In addition, various example embodiments enables 2D fabricated structures with unique pore distributions that can be subsequently reshaped into 3D structures for various purposes or applications. This capability enables an efficient and effective manner to apply additive manufacturing to fabricate 2D structures reconfigurable to 3D structures, which are otherwise fabricated layer-by-layer with support materials conventionally, thereby offering pronounced benefits for product design and manufacturing. Accordingly, various example embodiments of the present invention advantageously enable versatile control over porosity within FDM manufactured 2D and 3D structures. For example, the thin material extrusions segregated by the pores function as bending or fracture points within the structures. Pores aligned in 2D structures allow the structures to fold along the pore edges. The pores can also be aligned along 3D spaces to form negative channels or collapsing structures. Various example embodiments provide a physical prototyping technique that uses a computational design approach to redefine porosity within extrusion-based manufactured microporous structures. Offering versatility in achievable geometries, dimensions and distribution of pores, a graded variation of material properties can be precisely incorporated within the fabricated structures.

By way of examples only and without limitations, porous structures fabricated according to various example embodiments of the present invention may be utilized in a variety of industrial/commercial applications, such as but not limited to, immobilization splints; 3D printed cement walls with embedded ventilation and insulation; portable personal protective equipment; filtration systems for seed germination in hydroponics; dynamic facades; deployable satellites with self-folding structures; soft robotics; flexible electronics; textiles; and packaging.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of fabricating a porous structure based on extrusion-based additive manufacturing using at least one processor, the method comprising:
controlling a print head of an extruder to move along a print path for extruding a material along the print path on a print bed for fabricating the porous structure; and
controlling an extrusion flow rate of the extruder, while the print head is being controlled to move along the print path for extruding the material, for forming a plurality of pores of the porous structure, wherein for each pore of the plurality of pores, said controlling the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

2. The method according to claim 1, wherein
said adjusting the extrusion flow rate with respect to the first section of the print path comprises decreasing the extrusion flow rate with respect to the first section of the print path, and
said adjusting the extrusion flow rate with respect to the second section of the print path comprises decreasing the extrusion flow rate with respect to the second section of the print path.

3. The method according to claim 2, wherein
said decreasing the extrusion flow rate with respect to the first section of the print path forms the first extruded material portion along the first section of the print path having a thickness less than an extruded material portion formed along the print path immediately prior to and/or after the first extruded material portion, and
said decreasing the extrusion flow rate with respect to the second section of the print path forms the second extruded material portion along the second section of the print path having a thickness less than an extruded material portion formed along the print path immediately prior to and/or after the second extruded material portion.

4. The method according to claim 2, wherein
said decreasing the extrusion flow rate with respect to the first section of the print path and said decreasing the extrusion flow rate with respect to the second section of the print path are each performed based on a function having an output corresponding the extrusion flow rate.

5. The method according to claim 4, wherein
said decreasing the extrusion flow rate with respect to the first section of the print path comprises setting the extrusion flow rate with respect to a first plurality of positions along the first section of the print path based on a first plurality of outputs of the function with respect to the first plurality of positions, respectively, and
said decreasing the extrusion flow rate with respect to the second section of the print path comprises setting the extrusion flow rate with respect to a second plurality of positions along the second section of the print path based on a second plurality of outputs of the function with respect to the second plurality of positions, respectively.

6. The method according to claim 5, wherein the function is a polynomial function, and the method further comprises controlling a profile shape of the pore formed based on a first input parameter for configuring a degree of the polynomial function.

7. (canceled)

8. The method according to claim 6, further comprising configuring the polynomial function based on a second input parameter for setting a maximum extrusion flow rate and a third input parameter for setting a minimum extrusion flow rate.

9. The method according to claim 5, wherein
said controlling the extrusion flow rate of the extruder comprises controlling a feed rate of the extruder for feeding a filament of the material to the print head, and
said setting the extrusion flow rate with respect to the first plurality of positions comprises setting the feed rate with respect to the first plurality of positions along the first section of the print path based on the first plurality of outputs of the function with respect to the first plurality of positions, respectively, and
said setting the extrusion flow rate with respect to the second plurality of positions comprises setting the feed rate with respect to the second plurality of positions along the second section of the print path based on the second plurality of outputs of the function with respect to the second plurality of positions, respectively.

10. The method according to claim 9, further comprising:
for each of the first plurality of positions along the first section of the print path, controlling a print speed of the print head with respect to the position so as to have an inverse relationship to the feed rate set with respect to the position; and
for each of the second plurality of positions along the second section of the print path, controlling the print speed of the print head with respect to the position so as to have the inverse relationship to the feed rate set with respect to the position.

11. The method according to claim 1, wherein the plurality of pores is arranged to form one or more mechanical property varied portions of the porous structure, each mechanical property varied portion being configured to facilitate bending or fracturing thereat.

12. (canceled)

13. (canceled)

14. (canceled)

15. A system for fabricating a porous structure based on extrusion-based additive manufacturing, the system comprising:
at least one memory; and
at least one processor communicatively coupled to the at least one memory and configured to:
control a print head of an extruder to move along a print path for extruding a material along the print path on a print bed for fabricating the porous structure; and
control an extrusion flow rate of the extruder, while the print head is being controlled to move along the print path for extruding the material, for forming a plurality of pores of the porous structure, wherein for each pore of the plurality of pores, said control the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.

16. The system according to claim 15, wherein
said adjusting the extrusion flow rate with respect to the first section of the print path comprises decreasing the extrusion flow rate with respect to the first section of the print path, and
said adjusting the extrusion flow rate with respect to the second section of the print path comprises decreasing the extrusion flow rate with respect to the second section of the print path.

17. The system according to claim 16, wherein
said decreasing the extrusion flow rate with respect to the first section of the print path forms the first extruded material portion along the first section of the print path having a thickness less than an extruded material portion formed along the print path immediately prior to and/or after the first extruded material portion, and
said decreasing the extrusion flow rate with respect to the second section of the print path comprises forms the second extruded material portion along the second section of the print path having a thickness less than an extruded material portion formed along the print path immediately prior to and/or after the second extruded material portion.

18. The system according to claim 16, wherein
said decreasing the extrusion flow rate with respect to the first section of the print path and said decreasing the extrusion flow rate with respect to the second section of the print path are each performed based on a function having an output corresponding the extrusion flow rate.

19. The system according to claim 18, wherein
said decreasing the extrusion flow rate with respect to the first section of the print path comprises setting the extrusion flow rate with respect to a first plurality of positions along the first section of the print path based on a first plurality of outputs of the function with respect to the first plurality of positions, respectively, and
said decreasing the extrusion flow rate with respect to the second section of the print path comprises setting the extrusion flow rate with respect to a second plurality of positions along the second section of the print path based on a second plurality of outputs of the function with respect to the second plurality of positions, respectively.

20. The system according to claim 19, wherein the function is a polynomial function, and wherein the at least one processor is further configured to control a profile shape of the pore formed based on a first input parameter for configuring a degree of the polynomial function.

21. (canceled)

22. (canceled)

23. The system according to claim 19, wherein
said control the extrusion flow rate of the extruder comprises controlling a feed rate of the extruder for feeding a filament of the material to the print head,
said setting the extrusion flow rate with respect to the first plurality of positions comprises setting the feed rate with respect to the first plurality of positions along the first section of the print path based on the first plurality of outputs of the function with respect to the first plurality of positions, respectively, and
said setting the extrusion flow rate with respect to the second plurality of positions comprises setting the feed rate with respect to the second plurality of positions along the second section of the print path based on the second plurality of outputs of the function with respect to the second plurality of positions, respectively.

24. The system according to claim 23, wherein the at least one processor is further configured to:
for each of the first plurality of positions along the first section of the print path, control a print speed of the print head with respect to the position so as to have an inverse relationship to the feed rate set with respect to the position; and
for each of the second plurality of positions along the second section of the print path, control the print speed of the print head with respect to the position so as to have the inverse relationship to the feed rate set with respect to the position.

25. The system according to claim 15, wherein the plurality of pores is arranged to form one or more mechanical property varied portions of the porous structure, each mechanical property varied portion being configured to facilitate bending or fracturing thereat.

26. (canceled)

27. (canceled)

28. (canceled)

29. (canceled)

30. (canceled)

31. (canceled)

32. (canceled)

33. A computer program product, embodied in one or more non-transitory computer-readable storage mediums, comprising instructions executable by at least one processor to perform a method of fabricating a porous structure based on extrusion-based additive manufacturing, the method comprising:
controlling a print head of an extruder to move along a print path for extruding a material along the print path on a print bed for fabricating the porous structure; and
controlling an extrusion flow rate of the extruder, while the print head is being controlled to move along the print path for extruding the material, for forming a plurality of pores of the porous structure, wherein for each pore of the plurality of pores, said controlling the extrusion flow rate comprises adjusting the extrusion flow rate with respect to a first section of the print path to form a first extruded material portion along the first section of the print path and adjusting the extrusion flow rate with respect to a second section of the print path to form a second extruded material portion along the second section of the print path, the second extruded material portion formed being adjacent to and opposing the first extruded material portion formed, such that a space is formed therebetween constituting the pore.
